(19) United States
(12) Patent Application Publication
(10) Pub. No.: US 2024/0283578 A1
(43) Pub. Date: Aug. 22, 2024

(54) DYNAMICALLY OVERRIDING A HYBRID AUTOMATIC REPEAT REQUEST FEEDBACK CONFIGURATION

(71) Applicant: QUALCOMM Incorporated, San Diego, CA (US)

(72) Inventors: Alberto RICO ALVARINO, San Diego, CA (US); Ayan SENGUPTA, San Diego, CA (US); Le LIU, San Jose, CA (US); Bharat SHRESTHA, San Diego, CA (US); Umesh PHUYAL, San Diego, CA (US); Xiao Feng WANG, San Diego, CA (US); Liangping MA, San Diego, CA (US); Changhwan PARK, San Diego, CA (US)

(21) Appl. No.: 18/416,700

(22) Filed: Jan. 18, 2024

Related U.S. Application Data
(60) Provisional application No. 63/485,842, filed on Feb. 17, 2023.

(51) Int. Cl. H04L 1/1829; H04L 1/1812

(52) U.S. Cl. CPC H04L 1/1861; H04L 1/1812; H04L 1/1854

(57) ABSTRACT

Various aspects of the present disclosure generally relate to wireless communication. In some aspects, a user equipment (UE) may receive a radio resource control (RRC) configuration that indicates that hybrid automatic repeat request (HARQ) feedback associated with a downlink HARQ process is disabled or enabled. The UE may receive a downlink control information (DCI) communication that overrides the RRC configuration. The UE may selectively transmit HARQ feedback, associated with the downlink HARQ process, for a downlink transmission based at least in part on the DCI communication. The UE may selectively initiate, based at least in part on selectively transmitting the HARQ feedback, physical downlink control channel (PDCCH) monitoring associated with the downlink HARQ process based at least in part on at least one of the RRC configuration or the DCI communication. Numerous other aspects are described.

### CROSS-REFERENCE TO RELATED APPLICATION

This patent application claims priority to U.S. Provisional Patent Application No. 63/485,842, filed on Feb. 17, 2023, entitled “DYNAMICALLY OVERRIDING A HYBRID AUTOMATIC REPEAT REQUEST FEEDBACK CONFIGURATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for dynamically overriding a hybrid automatic repeat request feedback configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a radio resource control (RRC) configuration that indicates that hybrid automatic repeat request (HARQ) feedback associated with a downlink HARQ process is disabled or enabled. The method may include receiving a downlink control information (DCI) communication that overrides the RRC configuration. The method may include selectively transmitting HARQ feedback, associated with the downlink HARQ process, for a downlink transmission based at least in part on the DCI communication. The method may include selectively initiating, based at least in part on selectively transmitting the HARQ feedback, physical downlink control channel (PDCCH) monitoring associated with the downlink HARQ process based at least in part on at least one of the RRC configuration or the DCI communication.

Some aspects described herein relate to a method of wireless communication performed by a UE. The method may include receiving a first downlink communication that includes a respective semi-static uplink HARQ configuration for each of a plurality of uplink HARQ processes associated with the UE, where the respective semi-static uplink HARQ configurations indicate whether an uplink HARQ mode is enabled or disabled for each of the plurality of uplink HARQ processes. The method may include receiving a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Some aspects described herein relate to a method of wireless communication performed by a network node. The method may include transmitting an RRC configuration that indicates that HARQ feedback associated with a downlink HARQ process is disabled or enabled. The method may include transmitting a DCI communication that overrides the RRC configuration. The method may include selectively receiving HARQ feedback, associated with the downlink HARQ process, for a downlink transmission based at least in part on the DCI communication.

Some aspects described herein relate to a method of wireless communication performed by a network node. The method may include transmitting a first downlink communication that includes a respective semi-static uplink HARQ configuration for each of a plurality of uplink HARQ processes associated with a UE, where the respective semi-static uplink HARQ configurations indicate whether an uplink HARQ mode is enabled or disabled for each of the plurality of uplink HARQ processes. The method may include transmitting a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Some aspects described herein relate to a UE for wireless communication. The UE may include memory, one or more processors coupled to the memory, and instructions stored in the memory and executable by the one or more processors. The instructions may be executable by the one or more processors to cause the UE to receive an RRC configuration that indicates that HARQ feedback associated with a downlink HARQ process is disabled or enabled. The instructions may be executable by the one or more processors to cause the UE to receive a DCI communication that overrides the RRC configuration. The instructions may be executable by the one or more processors to cause the UE to selectively transmit HARQ feedback, associated with the downlink HARQ process, for a downlink transmission based at least in part on the DCI communication. The instructions may be executable by the one or more processors to cause the UE to selectively initiate, based at least in part on selectively transmitting the HARQ feedback, PDCCH monitoring associated with the downlink HARQ process based at least in part on at least one of the RRC configuration or the DCI communication.

Some aspects described herein relate to a UE for wireless communication. The UE may include memory, one or more processors coupled to the memory, and instructions stored in the memory and executable by the one or more processors. The instructions may be executable by the one or more processors to cause the UE to receive a first downlink communication that includes a respective semi-static uplink HARQ configuration for each of a plurality of uplink HARQ processes associated with the UE, where the respective semi-static uplink HARQ configurations indicate whether an uplink HARQ mode is enabled or disabled for each of the plurality of uplink HARQ processes. The instructions may be executable by the one or more processors to cause the UE to receive a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Some aspects described herein relate to a network node for wireless communication. The network node may include memory, one or more processors coupled to the memory, and instructions stored in the memory and executable by the one or more processors. The instructions may be executable by the one or more processors to cause the network node to transmit an RRC configuration that indicates that HARQ feedback associated with a downlink HARQ process is disabled or enabled. The instructions may be executable by the one or more processors to cause the network node to transmit a DCI communication that overrides the RRC configuration. The instructions may be executable by the one or more processors to cause the network node to selectively receive HARQ feedback, associated with the downlink HARQ process, for a downlink transmission based at least in part on the DCI communication.

Some aspects described herein relate to a network node for wireless communication. The network node may include memory, one or more processors coupled to the memory, and instructions stored in the memory and executable by the one or more processors. The instructions may be executable by the one or more processors to cause the network node to transmit a first downlink communication that includes a respective semi-static uplink HARQ configuration for each of a plurality of uplink HARQ processes associated with a UE, where the respective semi-static uplink HARQ configurations indicate whether an uplink HARQ mode is enabled or disabled for each of the plurality of uplink HARQ processes. The instructions may be executable by the one or more processors to cause the network node to transmit a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Some aspects described herein relate to a non-transitory computer-readable medium that stores one or more instructions for wireless communication by a UE. The one or more instructions, when executed by one or more processors of the UE, may cause the UE to receive an RRC configuration that indicates that HARQ feedback associated with a downlink HARQ process is disabled or enabled. The one or more instructions, when executed by one or more processors of the UE, may cause the UE to receive a DCI communication that overrides the RRC configuration. The one or more instructions, when executed by one or more processors of the UE, may cause the UE to selectively transmit HARQ feedback, associated with the downlink HARQ process, for a downlink transmission based at least in part on the DCI communication. The one or more instructions, when executed by one or more processors of the UE, may cause the UE to selectively initiate, based at least in part on selectively transmitting the HARQ feedback, PDCCH monitoring associated with the downlink HARQ process based at least in part on at least one of the RRC configuration or the DCI communication.

Some aspects described herein relate to a non-transitory computer-readable medium that stores one or more instructions for wireless communication by a UE. The one or more instructions, when executed by one or more processors of the UE, may cause the UE to receive a first downlink communication that includes a respective semi-static uplink HARQ configuration for each of a plurality of uplink HARQ processes associated with the UE, where the respective semi-static uplink HARQ configurations indicate whether an uplink HARQ mode is enabled or disabled for each of the plurality of uplink HARQ processes. The one or more instructions, when executed by one or more processors of the UE, may cause the UE to receive a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Some aspects described herein relate to a non-transitory computer-readable medium that stores one or more instructions for wireless communication by a network node. The one or more instructions, when executed by one or more processors of the network node, may cause the network node to transmit an RRC configuration that indicates that HARQ feedback associated with a downlink HARQ process is disabled or enabled. The one or more instructions, when executed by one or more processors of the network node, may cause the network node to transmit a DCI communication that overrides the RRC configuration. The one or more instructions, when executed by one or more processors of the network node, may cause the network node to selectively receive HARQ feedback, associated with the downlink HARQ process, for a downlink transmission based at least in part on the DCI communication.

Some aspects described herein relate to a non-transitory computer-readable medium that stores one or more instructions for wireless communication by a network node. The one or more instructions, when executed by one or more processors of the network node, may cause the network node to transmit a first downlink communication that includes a respective semi-static uplink HARQ configuration for each of a plurality of uplink HARQ processes associated with a UE, where the respective semi-static uplink HARQ configurations indicate whether an uplink HARQ mode is enabled or disabled for each of the plurality of uplink HARQ processes. The one or more instructions, when executed by one or more processors of the network node, may cause the network node to transmit a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Some aspects described herein relate to an apparatus for wireless communication. The apparatus may include means for receiving an RRC configuration that indicates that HARQ feedback associated with a downlink HARQ process is disabled or enabled. The apparatus may include means for receiving a DCI communication that overrides the RRC configuration. The apparatus may include means for selectively transmitting HARQ feedback, associated with the downlink HARQ process, for a downlink transmission based at least in part on the DCI communication. The apparatus may include means for selectively initiating, based at least in part on selectively transmitting the HARQ feedback, PDCCH monitoring associated with the downlink HARQ process based at least in part on at least one of the RRC configuration or the DCI communication.

Some aspects described herein relate to an apparatus for wireless communication. The apparatus may include means for receiving a first downlink communication that includes a respective semi-static uplink HARQ configuration for each of a plurality of uplink HARQ processes associated with the apparatus, where the respective semi-static uplink HARQ configurations indicate whether an uplink HARQ mode is enabled or disabled for each of the plurality of uplink HARQ processes. The apparatus may include means for receiving a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Some aspects described herein relate to an apparatus for wireless communication. The apparatus may include means for transmitting an RRC configuration that indicates that HARQ feedback associated with a downlink HARQ process is disabled or enabled. The apparatus may include means for transmitting a DCI communication that overrides the RRC configuration. The apparatus may include means for selectively receiving HARQ feedback, associated with the downlink HARQ process, for a downlink transmission based at least in part on the DCI communication.

Some aspects described herein relate to an apparatus for wireless communication. The apparatus may include means for transmitting a first downlink communication that includes a respective semi-static uplink HARQ configuration for each of a plurality of uplink HARQ processes associated with a UE, where the respective semi-static uplink HARQ configurations indicate whether an uplink HARQ mode is enabled or disabled for each of the plurality of uplink HARQ processes. The apparatus may include means for transmitting a second downlink communication that includes a dynamic uplink HARQ configuration for an uplink HARQ process of the plurality of uplink HARQ processes, where the dynamic uplink HARQ configuration at least partially overrides a semi-static uplink HARQ configuration, indicated in the first downlink communication, associated with the uplink HARQ process.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a regenerative deployment and an example of a transparent deployment in a non-terrestrial network.

FIGS. 5A and 5B are diagrams of examples of hybrid automatic repeat request (HARQ) feedback, in accordance with the present disclosure.

FIGS. 6A-6C are diagrams of examples of dynamically overriding a HARQ feedback configuration, in accordance with the present disclosure.

FIG. 7 is a diagram of an example of dynamically overriding a HARQ feedback configuration, in accordance with the present disclosure.

FIG. 8 is a diagram illustrating an example process performed, for example, by a UE, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

In a wireless network, a user equipment (UE) may communicate with various types of network nodes. For example, a UE may communicate with a ground-based network node, such as a macro base station, a small cell base station, and/or another type of ground-based base station. In some cases, a UE may communicate with a non-terrestrial network (NTN) network node such as a satellite base station.

A UE and an NTN network node may experience long round-trip times (RTTs), which may refer to the time duration for a wireless communication to propagate from the UE to the NTN network node and back to the UE (or vice-versa). The long RTTs may occur due to the long distance between the UE and the NTN network node, among other factors. The long RTTs between the UE and the NTN network node may result in challenges with implementing hybrid automatic repeat request (HARQ) feedback for wireless communications exchanged between the UE and the NTN network node. For example, the NTN network node may transmit a downlink communication to the UE, and may wait for HARQ feedback from the UE for the downlink communication before transmitting the next downlink communication to the UE. The long RTTs between the UE and the NTN network node may cause delays in receiving HARQ feedback at the NTN network node, which may reduce data transfer rates between the UE and the NTN network node and/or may increase communication latency between the UE and the NTN network node, among other examples.

In some cases, the NTN network node may be permitted to semi-statically disable HARQ feedback for one or more HARQ processes used by the UE and the NTN network node. For example, the NTN network node may provide a radio resource control (RRC) configuration to the UE in which HARQ feedback is disabled for a subset of HARQ processes for the UE. If the UE receives a downlink transmission from the NTN network node, and HARQ feedback is disabled for a HARQ process associated with the downlink transmission, the UE may refrain from providing HARQ feedback to the NTN network node for the downlink transmission.

In some cases, a UE may be capable of handling only a limited quantity of HARQ processes. For example, a narrow-band Internet-of-things (NB-IoT) UE or an evolved or enhanced machine-type communication (eMTC) UE configured with coverage enhancement mode B may be limited to only 1 or 2 HARQ processes. For these types of UEs, semi-statically disabling a HARQ process may severely reduce the ability of a UE to provide HARQ feedback to an NTN network node. As a result, the NTN network node may be unable to receive HARQ feedback or may be limited to significantly reduced HARQ feedback. This may restrict the NTN network node's ability to adjust or tune downlink transmission parameters for transmissions to the UE, which may decrease communication reliability between the UE and the NTN network node.

In some aspects described herein, a network node (e.g., an NTN network node and/or another type of network node) may dynamically override a semi-static configuration for one or more HARQ processes associated with a UE. For example, the network node may dynamically enable HARQ feedback for a HARQ process that has been semi-statically configured (e.g., RRC configured) with HARQ feedback disabled. As another example, the network node may dynamically disable HARQ feedback for a HARQ process that has been semi-statically configured (e.g., RRC configured) with HARQ feedback enabled. Moreover, the network node may semi-statically configure (e.g., by RRC configuration) and/or may dynamically configure (e.g., by downlink control information (DCI) configuration) the use of a HARQ RTT timer for one or more HARQ processes associated with the UE.

The ability of the network node to dynamically override the semi-static configuration for one or more HARQ processes associated with a UE enables the network node to more efficiently and more flexibly utilize the HARQ processes, particularly for UEs that are capable of handling only a limited quantity of HARQ processes. This may enable the network node to semi-statically disable HARQ feedback for UEs that have a long RTT between the UE and the network node, while still enabling the network node to dynamically obtain HARQ feedback from the UE to modify or tune downlink transmission parameters. This may increase data transfer rates between the UE and the network node, may decrease latency and/or delays between the UE and the network node, and/or may increase communication between the UE and the network node, among other examples.

The ability of the network node to semi-statically configure and/or may dynamically configure the use of a HARQ RTT timer for one or more HARQ processes associated with the UE enables the UE to more effectively utilize discontinuous reception (DRX) sleep mode or inactive mode. In particular, in cases where the network node disables (semi-statically and/or dynamically) HARQ feedback for a HARQ process associated with the UE, the network node may also disable (semi-statically and/or dynamically) the use of a HARQ RTT timer since the network node will not be performing retransmissions in cases where the UE is not providing HARQ feedback. This enables the UE to enter DRX sleep mode or inactive mode sooner, which may reduce power consumption for the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

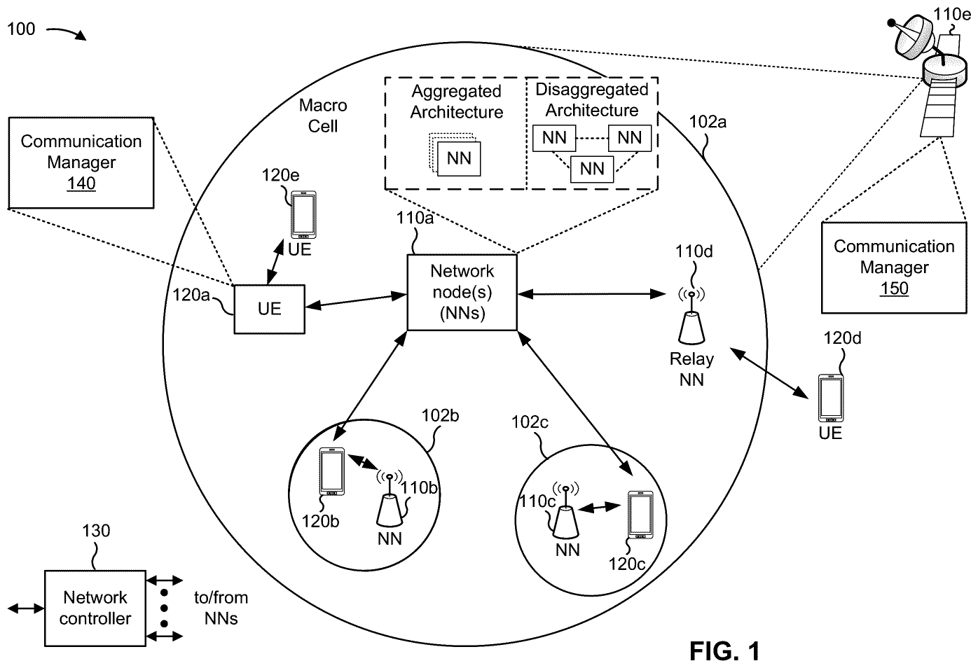

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

In some aspects, the wireless network 100 may include one or more non-terrestrial network (NTN) deployments in which a non-terrestrial wireless communication device may include a non-terrestrial network node or NTN network node 110e (or non-terrestrial network node) and/or a relay station (referred to herein, interchangeably, as a “non-terrestrial relay station”). As used herein, an NTN may refer to a network for which access is facilitated by a non-terrestrial network node and/or a non-terrestrial relay station.

The wireless network 100 may include any number of NTN network nodes 110e. An NTN network nodes 110e may include a satellite and/or a high-altitude platform (HAP). A HAP may include a balloon, a dirigible, an airplane, and/or an unmanned aerial vehicle. An NTN network nodes 110e may be part of an NTN that is separate from the wireless network 100. Alternatively, an NTN may be part of the wireless network 100. Satellites may communicate directly and/or indirectly with other entities in wireless network 100 using satellite communication. The other entities may include UEs, other satellites in the one or more NTN deployments, other types of network nodes (e.g., stationary or ground-based network nodes), relay stations, and/or one or more components and/or devices included in a core network of wireless network 100.

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or eMTC UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE 120 may include a communication manager 140. As described in more detail elsewhere herein, the communication manager 140 may receive an RRC configuration that indicates that HARQ feedback associated with a downlink HARQ process is disabled or enabled; receive a DCI communication that overrides the RRC configuration; selectively transmit HARQ feedback, associated with the downlink HARQ process, for a downlink transmission based at least in part on the DCI communication; and selectively initiate, based at least in part on selectively transmitting the HARQ feedback, PDCCH monitoring associated with the downlink HARQ process based at least in part on at least one of the RRC configuration or the DCI communication. Additionally, or alternatively, the communication manager 140 may perform one or more other operations described herein.

In some aspects, the communication manager 140 may receive a first downlink communication that includes a respective semi-static uplink HARQ configuration for each of a plurality of uplink HARQ processes associated with the UE, wherein the respective semi-static uplink HARQ configurations indicate whether an uplink HARQ mode is enabled or disabled for each of the plurality of uplink HARQ processes; and receive a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process. Additionally, or alternatively, the communication manager 140 may perform one or more other operations described herein.

In some aspects, a network node 110 may include a communication manager 150. As described in more detail elsewhere herein, the communication manager 150 may transmit an RRC configuration that indicates that HARQ feedback associated with a downlink HARQ process is disabled or enabled; transmit a DCI communication that overrides the RRC configuration; and selectively receive HARQ feedback, associated with the downlink HARQ process, for a downlink transmission based at least in part on the DCI communication. Additionally, or alternatively, the communication manager 150 may perform one or more other operations described herein.

In some aspects, the communication manager 150 may transmit a first downlink communication that includes a respective semi-static uplink HARQ configuration for each of a plurality of uplink HARQ processes associated with the UE, wherein the respective semi-static uplink HARQ configurations indicate whether an uplink HARQ mode is enabled or disabled for each of the plurality of uplink HARQ processes; and transmit a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process. Additionally, or alternatively, the communication manager 150 may perform one or more other operations described herein.

As indicated above, FIG. 1 is provided as an example. Other examples may differ from what is described with regard to FIG. 1.

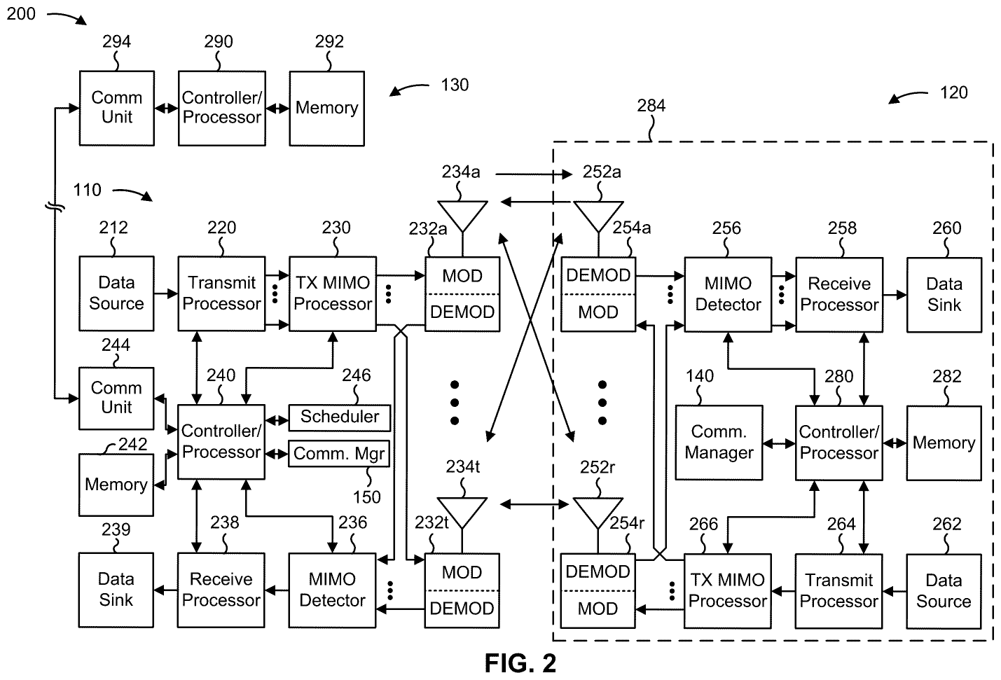

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

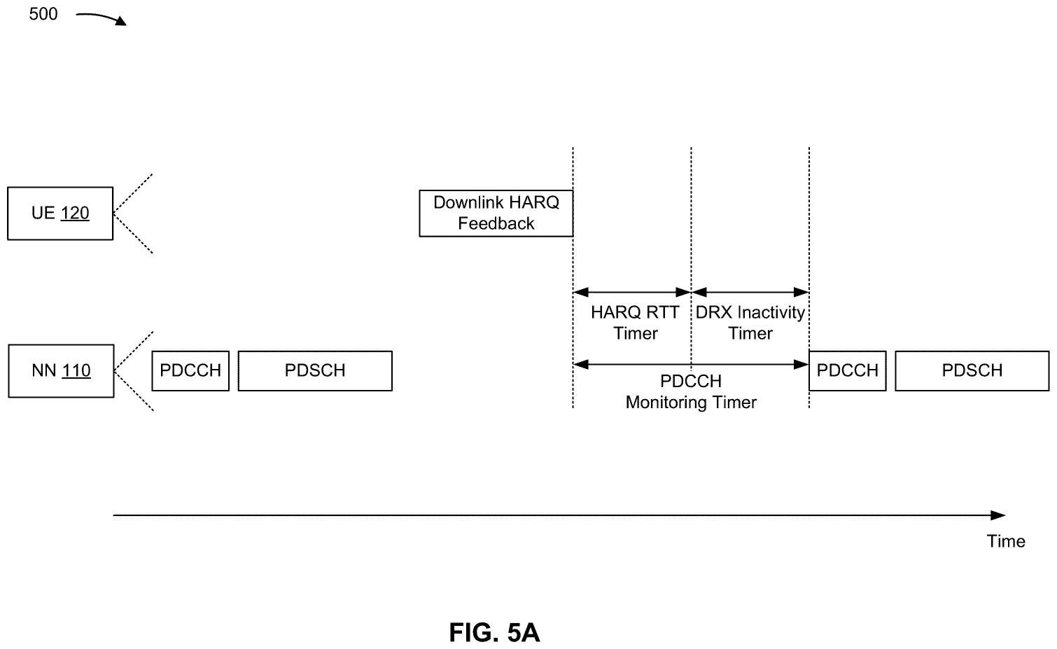

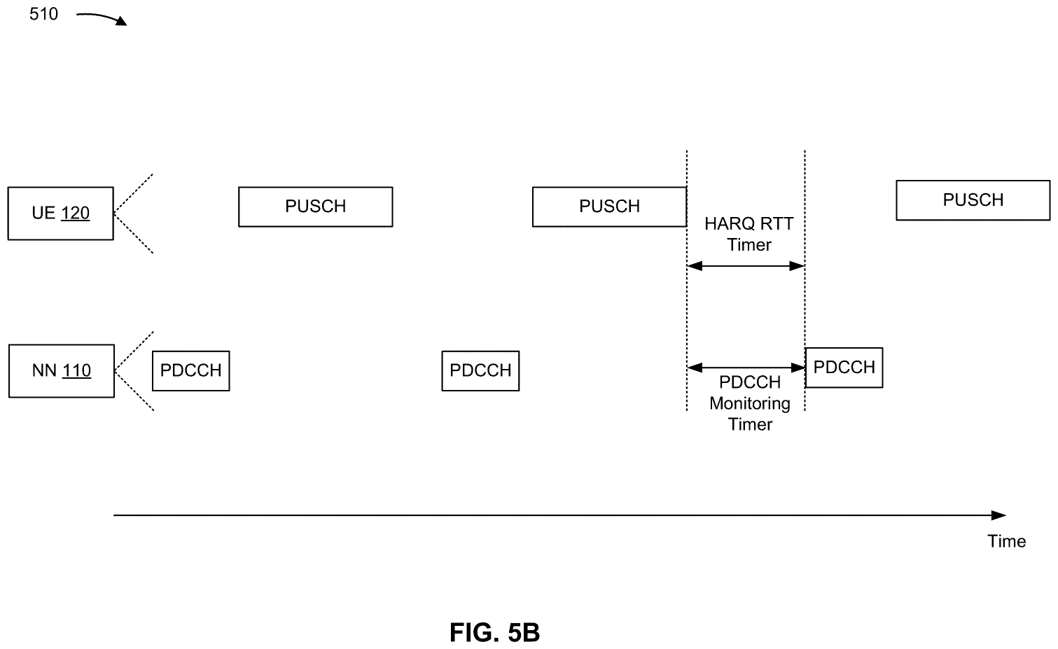

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-13).

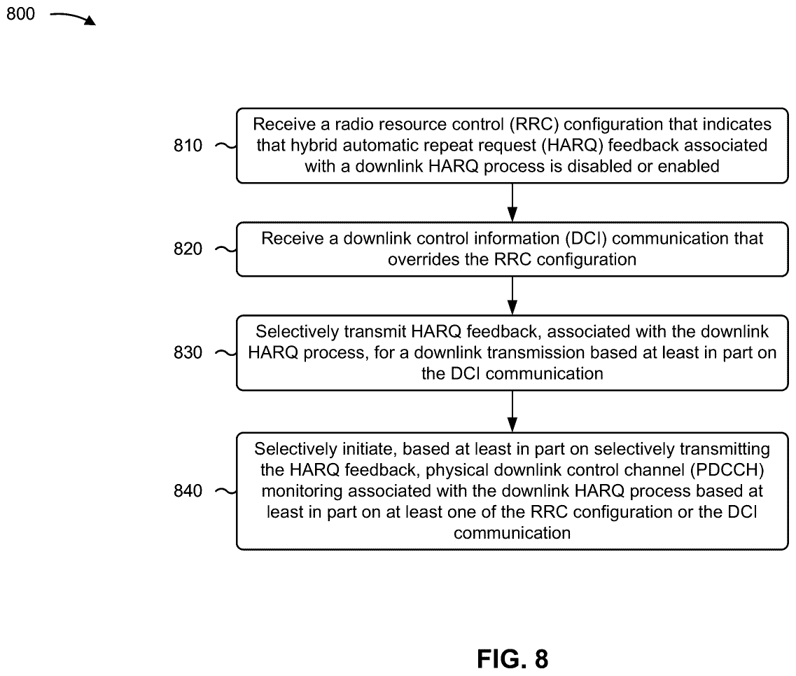

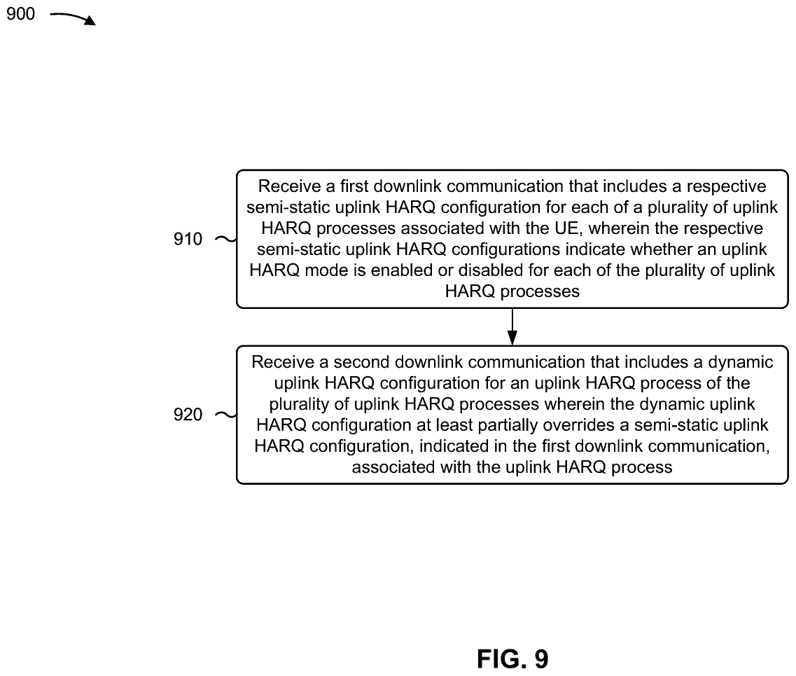

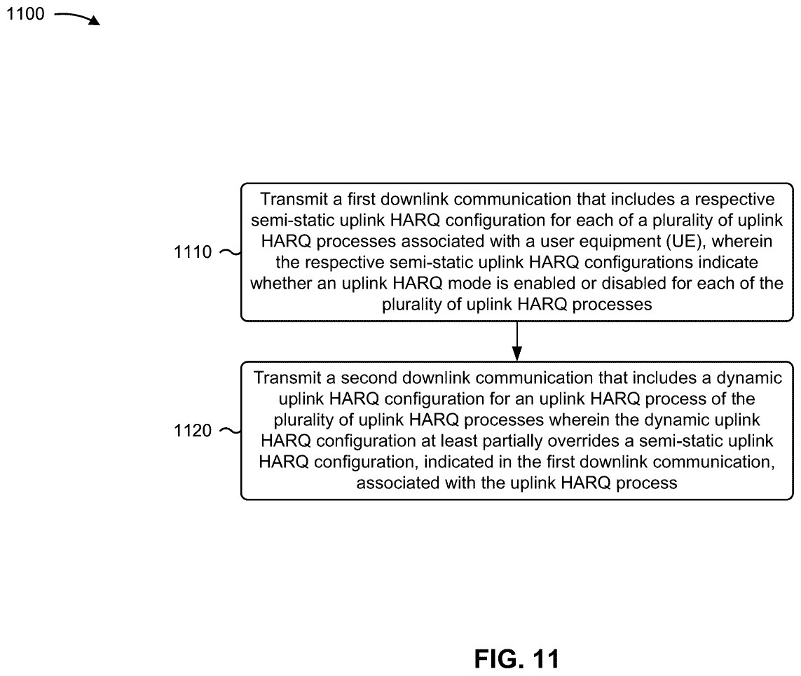

The controller/processor 240 of the network node 110, the controller/processor 280 of the UE 120, and/or any other component(s) of FIG. 2 may perform one or more techniques associated with dynamically overriding a HARQ feedback configuration, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 11, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 11, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving an RRC configuration that indicates that HARQ feedback associated with a downlink HARQ process is disabled or enabled; means for receiving a DCI communication that overrides the RRC configuration; means for selectively transmitting HARQ feedback, associated with the downlink HARQ process, for a downlink transmission based at least in part on the DCI communication; and/or means for selectively initiating, based at least in part on selectively transmitting the HARQ feedback, PDCCH monitoring associated with the downlink HARQ process based at least in part on at least one of the RRC configuration or the DCI communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving a first downlink communication that includes a respective semi-static uplink HARQ configuration for each of a plurality of uplink HARQ processes associated with the UE 120, wherein the respective semi-static uplink HARQ configurations indicate whether an uplink HARQ mode is enabled or disabled for each of the plurality of uplink HARQ processes; and/or means for receiving a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an RRC configuration that indicates that HARQ feedback associated with a downlink HARQ process is disabled or enabled; means for transmitting a DCI communication that overrides the RRC configuration; and/or means for selectively receiving HARQ feedback, associated with the downlink HARQ process, for a downlink transmission based at least in part on the DCI communication. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node 110 includes means for transmitting a first downlink communication that includes a respective semi-static uplink HARQ configuration for each of a plurality of uplink HARQ processes associated with the UE 120, wherein the respective semi-static uplink HARQ configurations indicate whether an uplink HARQ mode is enabled or disabled for each of the plurality of uplink HARQ processes; and/or means for transmitting a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

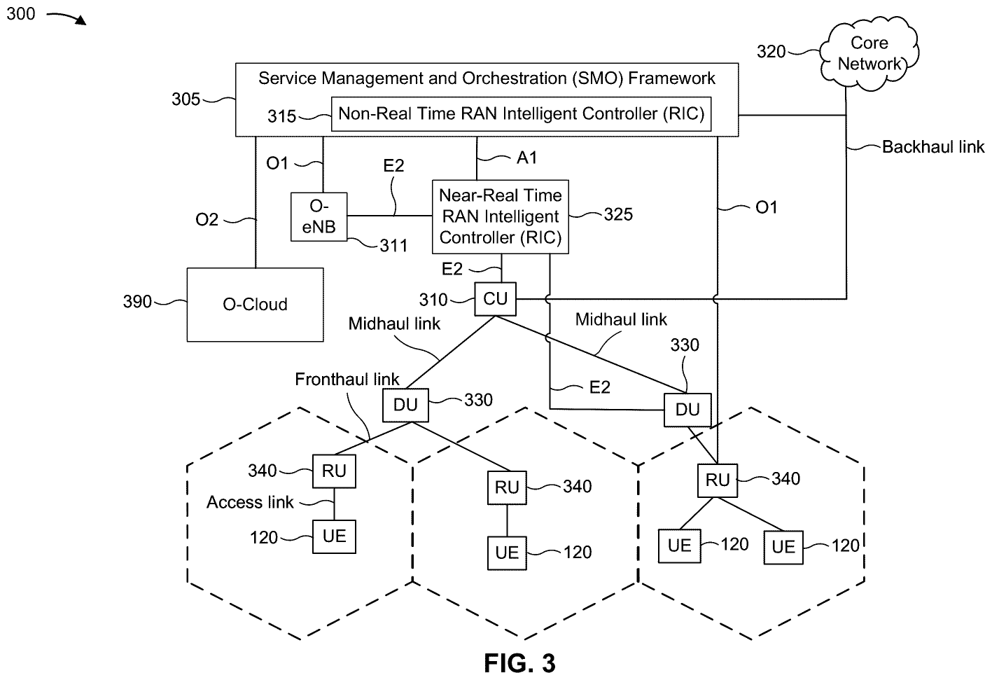

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340. In some aspects, an RU 340 may implement, or may be implemented by, an NTN network node 110c.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

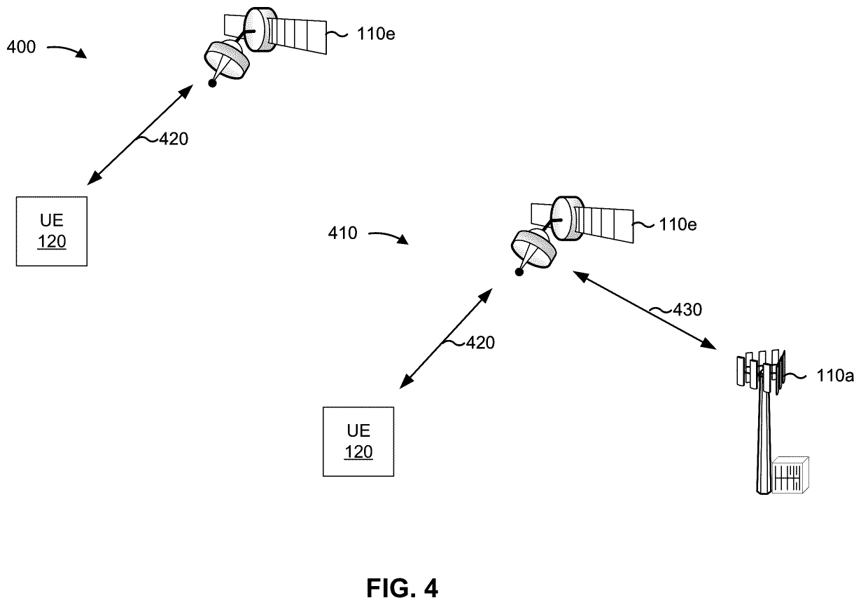

FIG. 4 is a diagram illustrating an example 400 of a regenerative deployment and an example 410 of a transparent deployment in a non-terrestrial network.

Example 400 shows a regenerative deployment. In example 400, a UE 120 is served by an NTN network node 110e via a service link 420. For example, the NTN network node 110e may include a satellite, an HAP, and/or another type of NTN network node. In some aspects, the NTN network node 110e may be referred to as a non-terrestrial base station, a regenerative repeater, or an on-board processing repeater. In some aspects, the NTN network node 110e may demodulate an uplink radio frequency signal, and may modulate a baseband signal derived from the uplink radio signal to produce a downlink radio frequency transmission. The NTN network node 110e may transmit the downlink radio frequency signal on the service link 420. The NTN network node 110e may provide a cell that covers the UE 120.

Example 410 shows a transparent deployment, which may also be referred to as a bent-pipe satellite deployment. In example 410, a UE 120 is served by an NTN network node 110e via the service link 420. The NTN network node 110e may be a transparent satellite. The NTN network node 110e may relay a signal received from a network node 110a (e.g., a ground-based network node) via a feeder link 430. For example, the NTN network node 110e may receive an uplink radio frequency transmission, and may transmit a downlink radio frequency transmission without demodulating the uplink radio frequency transmission. In some aspects, the NTN network node 110e may frequency convert the uplink radio frequency transmission received on the service link 420 to a frequency of the uplink radio frequency transmission on the feeder link 430, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The NTN network node 110e may provide a cell that covers the UE 120.

The service link 420 may include a link between the NTN network node 110e and the UE 120, and may include one or more of an uplink or a downlink. The feeder link 430 may include a link between the NTN network node 110e and the network node 110a, and may include one or more of an uplink (e.g., from the UE 120 to the network node 110a) or a downlink (e.g., from the network node 110a to the UE 120).

As indicated above, the UE 120 and the NTN network node 110e may experience long RTTs between the UE 120 and the NTN network node 110e due to the large distance between the UE 120 and the NTN network node 110e. The long RTTs between the UE 120 and the NTN network node 110e may cause delays in receiving HARQ feedback at the NTN network node 110e, which may reduce data transfer rates between the UE 120 and the NTN network node 110e and/or may increase communication latency between the UE 120 and the NTN network node 110a, among other examples.

As described herein, the NTN network node 110e may dynamically override a semi-static configuration for one or more HARQ processes associated with the UE 120. The ability of the NTN network node 110e to dynamically override the semi-static configuration for one or more HARQ processes associated with a UE 120 enables the NTN network node 110e to more efficiently and more flexibly utilize the HARQ processes, particularly if the UE 120 is capable of handling only a limited quantity of HARQ processes. This may enable the NTN network node 110e to semi-statically disable HARQ feedback for the UE 120 while still enabling the network node to dynamically obtain HARQ feedback from the UE 120 to modify or tune downlink transmission parameters. This may increase data transfer rates between the UE 120 and the NTN network node 110e, may decrease latency and/or delays between the UE 120 and the NTN network node 110e, and/or may increase communication between the UE 120 and the NTN network node 110e, among other examples.

As indicated above, FIG. 4 is provided as an example. Other examples may differ from what is described with regard to FIG. 4.

FIGS. 5A and 5B are diagrams of examples of HARQ feedback, in accordance with the present disclosure. FIG. 5A illustrates an example 500 of downlink HARQ feedback (e.g., HARQ feedback provided for a downlink transmission). FIG. 5B illustrates an example 510 of uplink HARQ (e.g., implicit HARQ feedback for uplink transmissions). As shown in FIGS. 5A and 5B, the examples 500 and 510 may include communication between a network node 110 and a UE 120. The network node 110 and the UE 120 may be included in a wireless network, such as the wireless network 100. In some aspects, the network node 110 may include an NTN network node 110c. In some aspects, the network node 110 may be implemented in a disaggregated base station architecture 300.

As shown in FIG. 5A, the UE 120 may provide downlink HARQ feedback associated with one or more downlink transmissions from the network node 110. The one or more downlink transmissions may include a physical downlink control channel (PDCCH) communication, a physical downlink shared channel (PDSCH) communication, and/or another type of downlink communication. The downlink HARQ feedback may include a HARQ acknowledgement (HARQ-ACK) or a HARQ negative acknowledgement (HARQ-NACK). A HARQ-ACK may indicate that the one or more downlink transmissions were successfully received and/or successfully decoded by the UE 120. A HARQ-NACK may indicate that the one or more downlink transmissions were not successfully received and/or not successfully decoded by the UE 120. The UE 120 may transmit the downlink HARQ feedback to the network node 110 in an uplink transmission, such as a physical uplink shared channel (PUSCH) communication, a physical uplink control channel (PUCCH), a narrowband PUSCH (NPUSCH) communication, and/or another type of uplink transmission.

As further shown in FIG. 5A, the UE 120 may initiate one or more medium access control (MAC) timers based at least in part on transmission of the downlink HARQ feedback. As an example, the UE 120 may initiate a HARQ RTT timer (e.g., a HARQ-RTT-TimerDL-NTN) after transmission of the downlink HARQ feedback. Here, the UE 120 may start the HARQ RTT timer for a corresponding HARQ process in the first symbol after the end of the corresponding uplink transmission carrying the downlink HARQ feedback. As another example, the UE 120 may initiate a DRX inactivity timer (e.g., a drx_HARQ-RTT-TimerDL) after transmission of the downlink HARQ feedback. As another example, the UE 120 may initiate a PDCCH monitoring timer.

The time duration of the HARQ RTT timer may be equal to the duration of the latest available RTT value for the RTT between the UE 120 and the network node 110. The DRX inactivity timer may be started upon expiration of the HARQ RTT timer. Thus, the duration of the HARQ RTT timer accounts for the RTT between the UE 120 and the network node 110. The earliest retransmission that the UE 120 can expect from the network node 110 may occur at or after expiration of the HARQ RTT timer due to the RTT between the UE 120 and the network node 110.

During the duration of the DRX inactivity timer, the UE 120 may monitor for downlink transmissions (e.g., PDCCH communications, PDSCH communications) from the network node 110. If the UE 120 does not receive a downlink transmission from the network node 110 by the time the DRX inactivity timer expires, the UE 120 may transition to a DRX sleep mode or inactive mode to reduce the power consumption of the UE 120.

The UE 120 may initiate a PDCCH monitoring timer based at least in part on transmission of the downlink HARQ feedback. The PDCCH monitoring timer may run in parallel at least partially with the HARQ RTT timer and/or at least partially with the DRX inactivity timer. During the duration of the PDCCH monitoring timer, the UE 120 does not expect to receive another PDCCH (e.g., another narrowband PDCCH (NPDCCH)) for the same downlink HARQ process for which the downlink HARQ feedback was provided in the uplink transmission. In particular, if the UE 120 transmits the NPUSCH transmission with the downlink HARQ feedback associated with the downlink HARQ process (the NPUSCH transmission ending in subframe n), the UE 120 is not expected to receive an NPDCCH with DCI format NO/NI for the same downlink HARQ process (e.g., the downlink HARQ process with the same HARQ process identifier) as the NPUSCH transmission (e.g., in which the downlink HARQ feedback was provided) in any subframe starting from subframe n+1 to subframe n+3. Additionally and/or alternatively in aspects in which the network node 110 is an NTN network node 110e, if the UE 120 transmits the NPUSCH transmission with the downlink HARQ feedback associated with the downlink HARQ process (the NPUSCH transmission ending in subframe n), the UE 120 is not expected to receive an NPDCCH with DCI format NO/NI for the same downlink HARQ process (e.g., the downlink HARQ process with the same HARQ process identifier) as the NPUSCH transmission (e.g., in which the downlink HARQ feedback was provided) in any subframe that overlaps with uplink subframe n+1 to subframe n+K_{mac}+3. K_{mac} may be based at least in part on the RTT between the UE 120 and the NTN network node 110c.

As shown in FIG. 5B, the network node 110 may transmit PDCCH communications to the UE 120 to schedule one or more uplink transmissions from the UE 120. The one or more uplink transmissions may include a physical uplink control channel (PUCCH) communication, a physical uplink shared channel (PUSCH) communication, and/or another type of uplink communication.

The network node 110 may not provide explicit HARQ feedback for an uplink transmission transmitted from the UE 120 to the network node 110. However, a PDCCH communication transmitted by the network node 110 to the UE 120 may schedule a retransmission of an uplink transmission. Thus, the absence of a scheduled retransmission in a PDCCH communication may be an implicit HARQ-ACK for a previously transmitted uplink transmission, and the presence of a scheduled retransmission for a previously transmitted uplink transmission may be an implicit HARQ-NACK.

As further shown in FIG. 5B, the network node 110 may initiate one or more MAC timers based at least in part on transmission of an uplink transmission. As an example, the UE 120 may initiate a HARQ RTT timer after transmission of a PUSCH communication. Here, the UE 120 may start the HARQ RTT timer for a corresponding HARQ process in the first symbol after the end of the corresponding uplink transmission. After expiration of the HARQ RTT timer, the UE 120 may monitor for PDCCH communications from the network node 110.

The UE 120 may initiate a PDCCH monitoring timer based at least in part on transmission of the PUSCH communication. The PDCCH monitoring timer may run in parallel at least partially with the HARQ RTT timer. During the duration of the PDCCH monitoring timer, the UE 120 does not expect to receive another PDCCH (e.g., another NPDCCH) for the same downlink HARQ process for which the PUSCH communication was transmitted.

As indicated above, FIGS. 5A and 5B are provided as examples. Other examples may differ from what is described with regard to FIGS. 5A and 5B.

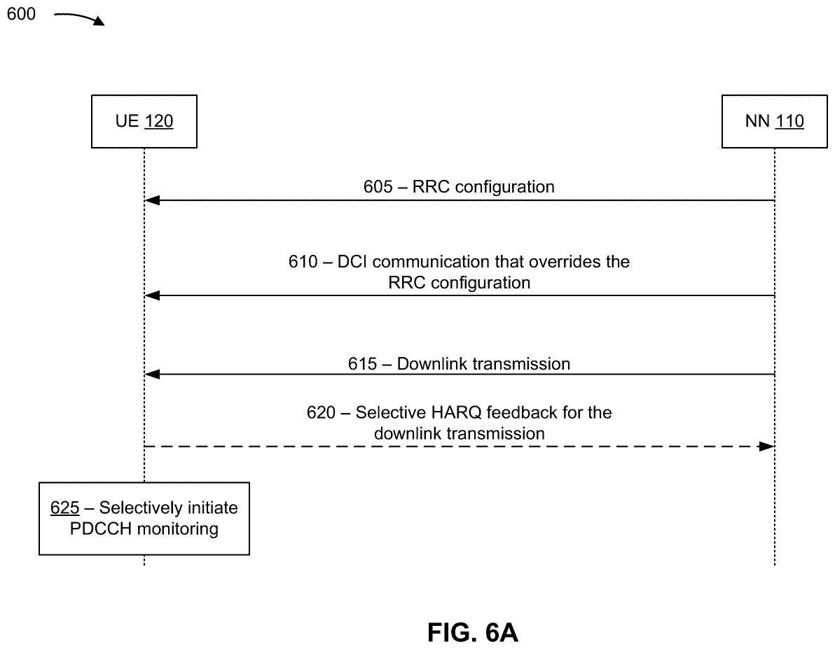

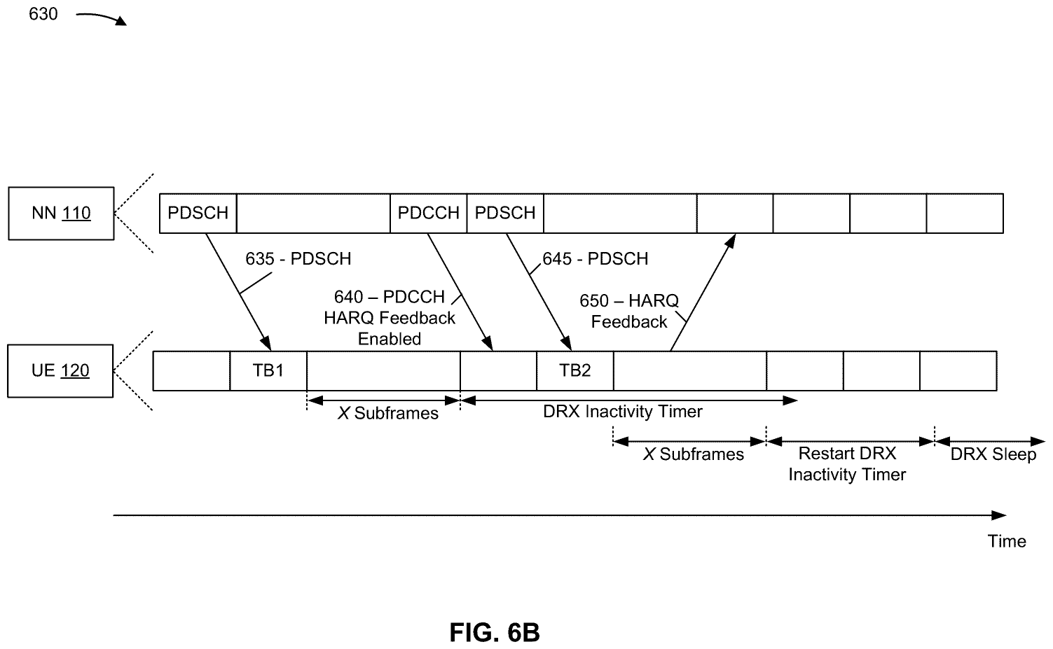

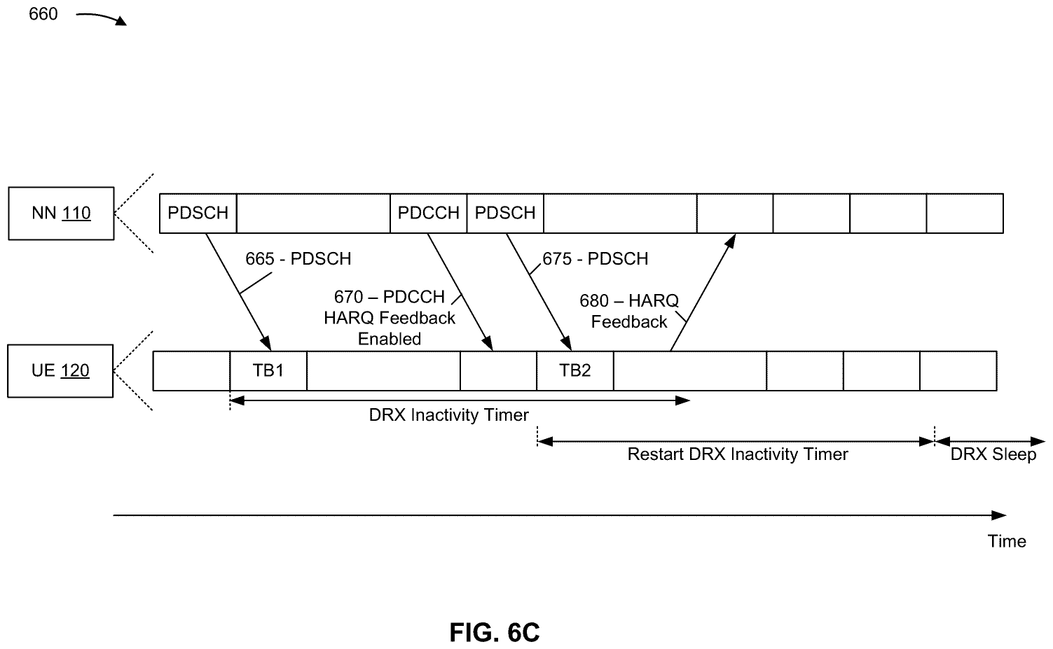

FIGS. 6A-6C are diagrams of examples of dynamically overriding a HARQ feedback configuration, in accordance with the present disclosure. As shown in FIGS. 6A-6C, the examples may include communication between a network node 110 and a UE 120. The network node 110 and the UE 120 may be included in a wireless network, such as the wireless network 100. In some aspects, the network node 110 may include an NTN network node 110e. In some aspects, the network node 110 may be implemented in a disaggregated base station architecture 300. In some aspects, the UE 120 may include an NB-IoT UE, an eMTC UE configured with coverage enhancement mode B, and/or another type of UE.

The UE 120 may be configured with a plurality of downlink HARQ processes that the UE 120 may use to provide HARQ feedback (e.g., downlink HARQ feedback) for one or more downlink transmissions transmitted by the network node 110. A downlink HARQ process may be used to track HARQ feedback and retransmissions for one or more downlink transmissions. The network node 110 may cycle through downlink HARQ processes so that HARQ feedback and retransmissions for a plurality of downlink transmissions may be tracked concurrently. Each downlink HARQ process may be associated with (or assigned) a HARQ process identifier. For example, a first downlink HARQ process may be associated with (or assigned) HARQ process identifier 0, a second downlink HARQ process may be associated with (or assigned) HARQ process identifier 1, and so on. In some aspects, different downlink HARQ processes may have different latency parameters and/or may be configured for different types of downlink transmissions. The network node 110 may schedule a downlink transmission, and may indicate the HARQ process identifier of the downlink HARQ process that the UE 120 is to use for providing HARQ feedback for the downlink transmission.

FIG. 6A illustrates an example 600 of dynamically overriding a HARQ feedback configuration. As shown in FIG. 6A, at 605, the network node 110 may transmit (and the UE 120 may receive) an RRC configuration. The RRC configuration may be included in an RRC communication and/or another type of downlink communication.

In some aspects, the RRC configuration may indicate that HARQ feedback associated with a downlink HARQ process, of the plurality of downlink HARQ processes associated with the UE 120, is disabled or enabled. For example, the RRC configuration may indicate that HARQ feedback is disabled for the downlink HARQ process. As another example, the RRC configuration may indicate that HARQ feedback is enabled for the downlink HARQ process. Alternatively, disabling and enabling of HARQ feedback for the downlink HARQ process may be omitted from the RRC configuration, and disabling and enabling of HARQ feedback for the downlink HARQ process may be configured dynamically by DCI.

HARQ feedback for the downlink HARQ process being “enabled” indicates to the UE 120 that the UE 120 is to provide HARQ feedback to the network node 110 for a downlink transmission if the downlink HARQ process is assigned to the downlink transmission. HARQ feedback for the downlink HARQ process being “disabled” indicates to the UE 120 that the UE 120 is to refrain from providing HARQ feedback to the network node 110 for a downlink transmission if the downlink HARQ process is assigned to the downlink transmission.

In some aspects, the RRC configuration may include a HARQ-ACK resource field (e.g., a field that is used to indicate one or more time domain resources and/or one or more frequency domain resources and/or other types of resources (e.g. sequence) in which HARQ feedback may be transmitted). In some aspects, the RRC configuration may include the HARQ-ACK resource field in cases in which the UE 120 is an NB-IoT UE or another type of UE. The network node 110 may configure the HARQ-ACK resource field to indicate whether HARQ feedback for the downlink HARQ process is disabled or enabled. For example, the network node 110 may configure the bits (e.g., 4 bits or another quantity of bits) of the HARQ-ACK resource field to include a particular value that is associated with HARQ feedback for the downlink HARQ process being disabled. As another example, the network node 110 may configure the bits of the HARQ-ACK resource field to include a particular value that is associated with HARQ feedback for the downlink HARQ process being enabled. Here, the particular value that is associated with HARQ feedback for the downlink HARQ process being enabled may also indicate the one or more time domain resources and/or one or more frequency domain resources and/or other types of resources (e.g. sequence) in which HARQ feedback may be transmitted.

In some aspects, the RRC configuration may include a HARQ-ACK resource offset field. In some aspects, the RRC configuration may include the HARQ-ACK resource offset field in cases in which the UE 120 is an eMTC UE configured with coverage enhancement mode B or another type of UE. The network node 110 may configure the HARQ-ACK resource offset field to indicate whether HARQ feedback for the downlink HARQ process is disabled or enabled. For example, the network node 110 may configure the bits (e.g., 2 bits or another quantity of bits) of the HARQ-ACK resource offset field to include a particular value that is associated with HARQ feedback for the downlink HARQ process being disabled. As another example, the network node 110 may configure the bits of the HARQ-ACK resource offset field to include a particular value that is associated with HARQ feedback for the downlink HARQ process being enabled. Here, the particular value that is associated with HARQ feedback for the downlink HARQ process being enabled may also indicate the one or more time domain resources and/or one or more frequency domain resources and/or other types of resources (e.g. sequence) in which HARQ feedback may be transmitted.

In some aspects, the RRC configuration may include a bitmap that the network node 110 may configure to indicate whether HARQ feedback is disabled or enabled for a plurality of downlink HARQ processes associated with the UE 120. The bitmap may be referred to as a HARQ process identifier bitmap. The HARQ process identifier bitmap is indicative of whether HARQ feedback is enabled or disabled for a set of HARQ process identifiers. Each position in the bitmap may correspond to a particular HARQ process identifier of a downlink HARQ process, and the value configured for each downlink HARQ process in the bitmap may indicate whether HARQ feedback is disabled or enabled for each downlink HARQ process. For example, a bitmap of 0011 may indicate that HARQ feedback is disabled for a first downlink HARQ process and second downlink HARQ process, and may indicate that HARQ feedback is enabled for a third downlink HARQ process and a fourth downlink HARQ process.

As further shown in FIG. 6A, at 610, the network node 110 may transmit (and the UE 120 may receive) a DCI communication that overrides the RRC configuration. In particular, the DCI communication may override the HARQ feedback configuration for a downlink HARQ process, associated with the UE 120, that was indicated in the RRC configuration. As an example, the RRC configuration may indicate that HARQ feedback is disabled for a downlink HARQ process associated with the UE 120, and the DCI communication may indicate that HARQ feedback is modified from disabled to enabled for the downlink HARQ process. As another example, the RRC configuration may indicate that HARQ feedback is enabled for a downlink HARQ process associated with the UE 120, and the DCI communication may indicate that HARQ feedback is modified from enabled to disabled for the downlink HARQ process.

In some aspects, the network node 110 is permitted to override the HARQ feedback configuration for a downlink HARQ process only if HARQ feedback for the downlink HARQ process is disabled in the RRC configuration. In these aspects, the network node 110 is permitted to modify the HARQ feedback from disabled to enabled in the DCI communication, but the network node 110 is not permitted to modify the HARQ feedback from enabled to disabled in the DCI communication.

In some aspects, the network node 110 is permitted to override the HARQ feedback configuration for a downlink HARQ process only if HARQ feedback for the downlink HARQ process is enabled in the RRC configuration. In these aspects, the network node 110 is permitted to modify the HARQ feedback from enabled to disabled in the DCI communication, but the network node 110 is not permitted to modify the HARQ feedback from disabled to enabled in the DCI communication.

In some aspects, the network node 110 is permitted to override the HARQ feedback configuration for a downlink HARQ process regardless of whether HARQ feedback for the downlink HARQ process is disabled or enabled in the RRC configuration. In these aspects, the network node 110 is permitted to modify the HARQ feedback from enabled to disabled in the DCI communication, as well as to modify the HARQ feedback from disabled to enabled in the DCI communication.

In some aspects, the DCI communication may include a scheduling DCI communication that schedules a downlink transmission from the network node. In some aspects, the DCI communication may include a HARQ-ACK resource field (e.g., a field that is used to indicate one or more time domain resources and/or one or more frequency domain resources and/or other types of resources (e.g. sequence) in which HARQ feedback may be transmitted). In some aspects, the DCI communication may include the HARQ-ACK resource field in cases in which the UE 120 is an NB-IoT UE or another type of UE. The network node 110 may configure the HARQ-ACK resource field to indicate whether HARQ feedback for the downlink HARQ process is disabled or enabled. For example, the network node 110 may configure the bits (e.g., 4 bits or another quantity of bits) of the HARQ-ACK resource field to include a particular value that is associated with HARQ feedback for the downlink HARQ process being disabled. As another example, the network node 110 may configure the bits of the HARQ-ACK resource field to include a particular value that is associated with HARQ feedback for the downlink HARQ process being enabled. Here, the particular value that is associated with HARQ feedback for the downlink HARQ process being enabled may also indicate the one or more time domain resources and/or one or more frequency domain resources and/or other types of resources (e.g. sequence) in which HARQ feedback may be transmitted.

In some aspects, the DCI communication may include a HARQ-ACK resource offset field. In some aspects, the RRC configuration may include the HARQ-ACK resource offset field in cases in which the UE 120 is an eMTC UE configured with coverage enhancement mode B or another type of UE. The network node 110 may configure the HARQ-ACK resource offset field to indicate whether HARQ feedback for the downlink HARQ process is disabled or enabled. For example, the network node 110 may configure the bits (e.g., 2 bits or another quantity of bits) of the HARQ-ACK resource offset field to include a particular value that is associated with HARQ feedback for the downlink HARQ process being disabled. As another example, the network node 110 may configure the bits of the HARQ-ACK resource offset field to include a particular value that is associated with HARQ feedback for the downlink HARQ process being enabled. Here, the particular value that is associated with HARQ feedback for the downlink HARQ process being enabled may also indicate the one or more time domain resources and/or one or more frequency domain resources and/or other types of resources (e.g. sequence) in which HARQ feedback may be transmitted.

As further shown in FIG. 6A, at 615, the network node 110 may transmit (and the UE 120 may receive) a downlink transmission. The network node 110 may transmit the downlink transmission after transmission of the RRC configuration and/or after transmission of the DCI communication. As indicated above, the DCI communication may be a scheduling DCI that schedules the downlink transmission. In these aspects, the DCI communication may indicate the HARQ process identifier associated with the downlink HARQ process that is assigned to the downlink transmission. Additionally and/or alternatively, the HARQ process identifier associated with the downlink HARQ process that is assigned to the downlink transmission may be indicated in another downlink communication transmitted from the network node 110 to the UE 120.

As further shown in FIG. 6A, at 620, the UE 120 may selectively transmit (and the network node 110 may selectively receive) HARQ feedback for the downlink transmission. In some aspects, the UE 120 may selectively transmit (and the network node 110 may selectively receive) HARQ feedback for the downlink transmission based at least in part on the DCI communication. For example, the DCI communication may override the RRC communication by modifying HARQ feedback, for the downlink HARQ process that is assigned to the downlink transmission, from disabled to enabled. Here, the UE 120 may transmit the HARQ feedback for the downlink transmission based at least in part on the DCI communication overriding the RRC communication by modifying HARQ feedback, for the downlink HARQ process that is assigned to the downlink transmission, from disabled to enabled.

As another example, the DCI communication may override the RRC communication by modifying HARQ feedback, for the downlink HARQ process that is assigned to the downlink transmission, from enabled to disabled. Here, the UE 120 may refrain from transmitting the HARQ feedback for the downlink transmission based at least in part on the DCI communication overriding the RRC communication by modifying HARQ feedback, for the downlink HARQ process that is assigned to the downlink transmission, from enabled to disabled.

As further shown in FIG. 6A, at 625, the UE 120 may selectively initiate PDCCH monitoring, which may include selectively initiating one or more timers (e.g. MAC timers). The one or more timers may include a HARQ RTT timer, a DRX inactivity timer, and/or a PDCCH monitoring timer, among other examples. The UE 120 may selectively initiate the HARQ RTT timer based at least in part on the RRC configuration and/or the DCI communication. For example, the UE 120 may follow the DCI communication and may initiate the HARQ RTT timer based at least in part on the DCI communication indicating that HARQ feedback for the downlink HARQ process is enabled. Here, the UE 120 may initiate the HARQ RTT timer after transmitting the HARQ feedback. The UE 120 may initiate a DRX inactivity timer if no subsequent downlink transmission is received by the expiration of the HARQ RTT timer.

As another example, the UE 120 may follow the DCI communication and may refrain from initiating the HARQ RTT timer based at least in part on the DCI communication indicating that HARQ feedback for the downlink HARQ process is disabled. Here, the UE 120 may initiate the DRX inactivity timer after reception of the downlink transmission.

In some aspects, the UE 120 may selectively initiate the HARQ RTT timer based at least in part on the RRC configuration, regardless of whether the DCI communication overrides the RRC configuration. For example, the UE 120 may follow the RRC configuration and may refrain from initiating the HARQ RTT timer based at least in part on the RRC configuration indicating that HARQ feedback for the downlink HARQ process is disabled. Here, the UE 120 may refrain from initiating the HARQ RTT timer regardless of whether the DCI communication overrides the RRC configuration by modifying the HARQ feedback from disabled to enabled for the downlink HARQ process. This enables the network node 110 to perform outer loop link adaptation for the UE 120 in that the network node 110 receives the HARQ feedback from the UE 120 for outer loop link adaptation without implementing retransmissions on the downlink (for which the UE 120 would otherwise initiate the HARQ RTT timer to monitor for the retransmissions).

In some aspects, the UE 120 determines whether to initiate the HARQ RTT timer based at least in part on an implicit indication in the RRC configuration and/or an implicit indication in the DCI communication. The implicit indication may be whether HARQ feedback for the downlink HARQ process is disabled or enabled. For example, the RRC configuration or the DCI communication may indicate that HARQ feedback for the downlink HARQ process is disabled, and the UE 120 may determine to refrain from initiating the HARQ RTT timer based at least in part on HARQ feedback for the downlink HARQ process being disabled. In some aspects, the UE 120 refrains from initiating the HARQ RTT timer based at least in part on HARQ feedback for the downlink HARQ process being disabled in at least one of the RRC configuration or the DCI communication.

In some aspects, the UE 120 determines whether to initiate the HARQ RTT timer based at least in part on an explicit indication in the RRC configuration and/or an explicit indication in the DCI communication. For example, the RRC configuration may include a first field indicating whether HARQ feedback for the downlink HARQ process is disabled or enabled, and a second field indicating whether the HARQ RTT timer for the downlink HARQ process is disabled or enabled. As another example, the DCI communication may include a first field indicating whether HARQ feedback for the downlink HARQ process is disabled or enabled, and a second field indicating whether the HARQ RTT timer for the downlink HARQ process is disabled or enabled. Combinations of the first field and the second field may include, but are not limited to, HARQ feedback enabled+HARQ RTT timer enabled, HARQ feedback enabled+HARQ RTT timer disabled, HARQ feedback disabled+HARQ RTT timer enabled, or HARQ feedback disabled+HARQ RTT timer disabled, among other examples.

In some aspects, the UE 120 determines whether to follow the RRC configuration or the DCI communication for determining whether to initiate the HARQ RTT timer based at least in part on whether the RRC configuration includes a bitmap for indicating whether HARQ feedback for downlink HARQ processes is disabled or enabled. For example, the UE 120 may determine to follow the RRC configuration for determining whether to initiate the HARQ RTT timer based at least in part on the RRC configuration including the bitmap. As another example, the UE 120 may determine to follow the DCI communication for determining whether to initiate the HARQ RTT timer based at least in part on the RRC configuration including the bitmap.

In some aspects, the UE 120 determines whether to follow the RRC configuration or the DCI communication for determining whether to initiate the HARQ RTT timer based at least in part on whether any of the downlink HARQ processes associated with the UE 120 are enabled. As an example, the UE 120 may determine to refrain from initiating the HARQ RTT timer based at least in part on no downlink HARQ process being enabled for the UE 120. As another example, the UE 120 may determine to follow the RRC configuration for determining whether to initiate the HARQ RTT timer based at least in part on no downlink HARQ process being enabled in the RRC configuration.

In some aspects, the UE 120 determines whether to follow the RRC configuration or the DCI communication for determining whether to initiate the HARQ RTT timer based at least in part on a quantity of the downlink HARQ processes configured for the UE 120. For example, the UE 120 may determine to follow the RRC configuration for determining whether to initiate the HARQ RTT timer based at least in part on one downlink HARQ process being configured for the UE 120. As another example, the UE 120 may determine to follow the DCI communication for determining whether to initiate the HARQ RTT timer based at least in part on one downlink HARQ process being configured for the UE 120. As another example, the UE 120 may determine to follow the RRC configuration for determining whether to initiate the HARQ RTT timer based at least in part on two downlink HARQ processes being configured for the UE 120. As another example, the UE 120 may determine to follow the DCI communication for determining whether to initiate the HARQ RTT timer based at least in part on two downlink HARQ processes being configured for the UE 120.

The UE 120 may selectively initiate the PDCCH monitoring timer based at least in part on the RRC configuration and/or the DCI communication. For example, the UE 120 may follow the DCI communication and may initiate the PDCCH monitoring timer based at least in part on the DCI communication indicating that HARQ feedback for the downlink HARQ process is enabled. Here, the UE 120 may initiate the PDCCH monitoring timer after transmitting the downlink HARQ feedback. Thus, the UE 120 waits for expiration of the PDCCH monitoring timer before expecting to receive another PDCCH associated with the same downlink HARQ process for which the downlink HARQ feedback was provided at 620.

As another example, the UE 120 may follow the DCI communication and may refrain from initiating the PDCCH monitoring timer based at least in part on the DCI communication indicating that HARQ feedback for the downlink HARQ process is disabled. Here, the UE 120 may expect, and may start monitoring for, a PDCCH (which may be a new transmission or a retransmission) associated with the same downlink HARQ process as the downlink transmission at 615.

In some aspects, the UE 120 may selectively initiate the associated with the same downlink HARQ process timer based at least in part on the RRC configuration, regardless of whether the DCI communication overrides the RRC configuration. For example, the UE 120 may follow the RRC configuration and may refrain from initiating the associated with the same downlink HARQ process timer based at least in part on the RRC configuration indicating that HARQ feedback for the downlink HARQ process is disabled. Here, the UE 120 may refrain from initiating the associated with the same downlink HARQ process timer regardless of whether the DCI communication overrides the RRC configuration by modifying the HARQ feedback from disabled to enabled for the downlink HARQ process. This enables the network node 110 to perform outer loop link adaptation for the UE 120 in that the network node 110 receives the HARQ feedback from the UE 120 for outer loop link adaptation without implementing retransmissions on the downlink (for which the UE 120 would otherwise initiate the PDCCH monitoring timer to wait for (re)transmissions using the same downlink HARQ process).

In some aspects, the UE 120 determines whether to initiate the PDCCH monitoring timer based at least in part on an implicit indication in the RRC configuration and/or an implicit indication in the DCI communication. The implicit indication may be whether HARQ feedback for the downlink HARQ process is disabled or enabled. For example, the RRC configuration or the DCI communication may indicate that HARQ feedback for the downlink HARQ process is disabled, and the UE 120 may determine to refrain from initiating the PDCCH monitoring timer based at least in part on HARQ feedback for the downlink HARQ process being disabled. In some aspects, the UE 120 refrains from initiating the PDCCH monitoring timer based at least in part on HARQ feedback for the downlink HARQ process being disabled in at least one of the RRC configuration or the DCI communication.

In some aspects, the UE 120 determines whether to initiate the PDCCH monitoring timer based at least in part on an explicit indication in the RRC configuration and/or an explicit indication in the DCI communication. For example, the RRC configuration may include a first field indicating whether HARQ feedback for the downlink HARQ process is disabled or enabled, and a second (or third) field indicating whether the PDCCH monitoring timer for the downlink HARQ process is disabled or enabled. As another example, the DCI communication may include a first field indicating whether HARQ feedback for the downlink HARQ process is disabled or enabled, and a second field indicating whether the PDCCH monitoring timer for the downlink HARQ process is disabled or enabled.

In some aspects, the UE 120 determines whether to follow the RRC configuration or the DCI communication for determining whether to initiate the PDCCH monitoring timer based at least in part on whether the RRC configuration includes a bitmap for indicating whether HARQ feedback for downlink HARQ processes is disabled or enabled. For example, the UE 120 may determine to follow the RRC configuration for determining whether to initiate the PDCCH monitoring timer based at least in part on the RRC configuration including the bitmap. As another example, the UE 120 may determine to follow the DCI communication for determining whether to initiate the PDCCH monitoring timer based at least in part on the RRC configuration including the bitmap.

In some aspects, the UE 120 determines whether to follow the RRC configuration or the DCI communication for determining whether to initiate the HARQ RTT timer based at least in part on whether any of the downlink HARQ processes associated with the UE 120 are enabled. As an example, the UE 120 may determine to refrain from initiating the PDCCH monitoring timer based at least in part on no downlink HARQ process being enabled for the UE 120. As another example, the UE 120 may determine to follow the RRC configuration for determining whether to initiate the PDCCH monitoring timer based at least in part on no downlink HARQ process being enabled in the RRC configuration.

In some aspects, the UE 120 determines whether to follow the RRC configuration or the DCI communication for determining whether to initiate the PDCCH monitoring timer based at least in part on a quantity of the downlink HARQ processes configured for the UE 120. For example, the UE 120 may determine to follow the RRC configuration for determining whether to initiate the PDCCH monitoring timer based at least in part on one downlink HARQ process being configured for the UE 120. As another example, the UE 120 may determine to follow the DCI communication for determining whether to initiate the PDCCH monitoring timer based at least in part on one downlink HARQ process being configured for the UE 120. As another example, the UE 120 may determine to follow the RRC configuration for determining whether to initiate the PDCCH monitoring timer based at least in part on two downlink HARQ processes being configured for the UE 120. As another example, the UE 120 may determine to follow the DCI communication for determining whether to initiate the PDCCH monitoring timer based at least in part on two downlink HARQ processes being configured for the UE 120.

FIG. 6B illustrates an example 630 of dynamically overriding a HARQ feedback configuration. As shown in FIG. 6B, at 635, the network node 110 may transmit (and the UE 120 may receive) a PDSCH communication. The PDSCH may be transmitted in a first transport block (TB1). The UE 120 may wait X subframes (e.g., 12 subframes or another quantity of subframes) before initiating a DRX inactivity timer if no additional downlink transmissions are received in the X subframes.

During the DRX inactivity timer duration, at 640, the network node 110 may transmit (and the UE 120 may receive) a PDCCH communication indicating that HARQ feedback is enabled for an associated downlink HARQ process. The PDCCH communication may include a DCI communication that indicates that an RRC configuration for the downlink HARQ process is overridden (e.g., the DCI communication modifies HARQ feedback from disabled to enabled for the downlink HARQ process).

Subsequently, at 645, the network node 110 may transmit (and the UE 120 may receive) a PDSCH communication. The downlink HARQ process may be assigned to the PDSCH communication. The PDSCH communication may be transmitted in a second transport block (TB2). At 650, the UE 120 may transmit (and the network node 110 may receive) HARQ feedback for the PDSCH communication.

When the UE 120 is RRC configured with HARQ feedback disabled for the downlink HARQ process, and the UE 120 is configured with only a single downlink HARQ process, the UE 120 may restart the DRX inactivity timer after another X subframes (e.g., 12 subframes or another quantity of subframes) or after a K_{delay} value from the last repetition of the PDSCH communication, whichever is a greater time duration. Alternatively, when the UE 120 is RRC configured with HARQ feedback enabled for the downlink HARQ process, and HARQ feedback is subsequently disabled in the PDCCH communication at 640, the UE 120 may restart the DRX inactivity timer after the last symbol of the transmission of the HARQ feedback. If the DRX inactivity timer expires after no additional downlink transmission is received, the UE 120 may transition to a DRX sleep mode.

FIG. 6C illustrates an example 660 of dynamically overriding a HARQ feedback configuration. As shown in FIG. 6C, at 665, the network node 110 may transmit (and the UE 120 may receive) a PDSCH communication. The PDSCH may be transmitted in a first transport block (TB1). When the UE 120 is RRC configured with HARQ feedback disabled for the downlink HARQ process, the UE 120 may initiate a DRX inactivity timer after K_{delay} from reception of the last repetition of any PDSCH communications.

During the DRX inactivity timer duration, at 670, the network node 110 may transmit (and the UE 120 may receive) a PDCCH communication indicating that HARQ feedback is enabled for an associated downlink HARQ process. The PDCCH communication may include a DCI communication that indicates that an RRC configuration for the downlink HARQ process is overridden (e.g., the DCI communication modifies HARQ feedback from disabled to enabled for the downlink HARQ process).

Subsequently, at 675, the network node 110 may transmit (and the UE 120 may receive) a PDSCH communication. The downlink HARQ process may be assigned to the PDSCH communication. The PDSCH communication may be transmitted in a second transport block (TB2). At 680, the UE 120 may transmit (and the network node 110 may receive) HARQ feedback for the PDSCH communication.

When the UE 120 is RRC configured with HARQ feedback disabled for the downlink HARQ process, the UE 120 may initiate a DRX inactivity timer after K_{delay} from reception of the last repetition of the PDSCH communication at 675.

In some aspects, K_{delay}=K+N+3+deltaPDCCH. K may correspond to the gap between the PDSCH communication at 675 and the HARQ feedback transmission at 680. N may correspond to a HARQ feedback repletion factor. DeltaPDCCH may correspond to a gap defined in a wireless communication standard such as 3GPP TS 36.321. In some aspects, K_{delay}=gap between last repetition of the PDSCH communication at 675 and the last repetition of the HARQ feedback transmission at 680.

Alternatively, the UE 120 is RRC configured with HARQ feedback enabled for the downlink HARQ process, and HARQ feedback is subsequently disabled in the PDCCH communication at 640, the UE 120 may restart the DRX inactivity timer after the last symbol of the transmission of the HARQ feedback. If the DRX inactivity timer expires after no additional downlink transmission is received, the UE 120 may transition to a DRX sleep mode.

As indicated above, FIGS. 6A-6C are provided as examples. Other examples may differ from what is described with regard to FIGS. 6A-6C.

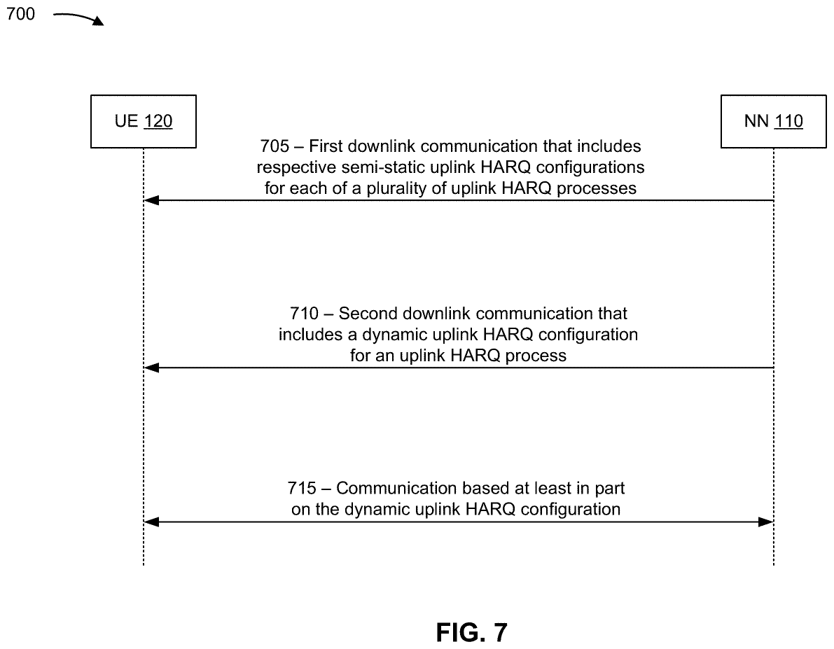

FIG. 7 is a diagram of an example 700 of dynamically overriding a HARQ feedback configuration, in accordance with the present disclosure. As shown in FIG. 7, the example 700 may include communication between a network node 110 and a UE 120. The network node 110 and the UE 120 may be included in a wireless network, such as the wireless network 100. In some aspects, the network node 110 may include an NTN network node 110e. In some aspects, the network node 110 may be implemented in a disaggregated base station architecture 300. In some aspects, the UE 120 may include an NB-IoT UE, an eMTC UE configured with coverage enhancement mode B, and/or another type of UE.

The UE 120 may be configured with a plurality of uplink HARQ processes that the network node 110 may use to track retransmissions for one or more uplink transmissions transmitted by the UE 120. The network node 110 may cycle through uplink HARQ processes so that retransmissions for a plurality of uplink transmissions may be tracked concurrently. Each uplink HARQ process may be associated with (or assigned) a HARQ process identifier. For example, a first uplink HARQ process may be associated with (or assigned) HARQ process identifier 0, a second uplink HARQ process may be associated with (or assigned) HARQ process identifier 1, and so on. In some aspects, different uplink HARQ processes may have different latency parameters and/or may be configured for different types of uplink transmissions. The network node 110 may schedule an uplink transmission, and may indicate the HARQ process identifier of the uplink HARQ process that the network node 110 is to use for tracking and/or scheduling retransmissions for the uplink transmission.

As shown in FIG. 7, at 705, the network node 110 may transmit (and the UE 120 may receive) a first downlink communication. The first downlink communication may include an RRC communication and/or another type of downlink communication. The first downlink communication may include respective semi-static uplink HARQ configurations for each of a plurality of uplink HARQ processes configured for the UE 120. For example, the first downlink communication may include a first semi-static uplink HARQ configuration for a first uplink HARQ process, a second semi-static uplink HARQ configuration for a second uplink HARQ process, a third semi-static uplink HARQ configuration for a third uplink HARQ process and so on.

In some aspects, a semi-static uplink HARQ configuration for an uplink HARQ process may include an indication of whether an uplink HARQ mode for the uplink HARQ process is disabled or enabled. The uplink HARQ mode being enabled may be referred to as Mode A (or HARQ Mode A), whereas the uplink HARQ mode being disabled is referred to as Mode B (or HARQ Mode B).

In some aspects, a semi-static uplink HARQ configuration for an uplink HARQ process may include an indication of whether a HARQ RTT timer for the uplink HARQ process is disabled or enabled. The HARQ RTT timer being enabled for the uplink HARQ process may be referred to as Mode A (or HARQ Mode A), whereas the HARQ RTT timer being disabled for the uplink HARQ process is referred to as Mode B (or HARQ Mode B). In some aspects, a semi-static uplink HARQ configuration for an uplink HARQ process may include an indication of whether a PDCCH monitoring timer for the uplink HARQ process is disabled or enabled. The PDCCH monitoring timer being enabled for the uplink HARQ process may be referred to as Mode A (or HARQ Mode A), whereas the PDCCH monitoring timer being disabled for the uplink HARQ process is referred to as Mode B (or HARQ Mode B).

In some aspects, a semi-static uplink HARQ configuration for an uplink HARQ process may include an indication of whether logical channel priority (LCP) prioritization for the uplink HARQ process is disabled or enabled. LCP prioritization being enabled for the uplink HARQ process may be referred to as Mode A (or HARQ Mode A), whereas LCP prioritization being disabled for the uplink HARQ process is referred to as Mode B (or HARQ Mode B). Per logical channel, the UE 120 may be configured with an allowedHARQ-mode-r17 parameter. This parameter may indicate the allowed HARQ mode of a HARQ process mapped to the logical channel. If the parameter is absent, there is no restriction for HARQ mode for the mapping. The allowedHARQ-mode-r17 parameter may apply various types of radio bearers, such as signaling radio bearer 1 (SRB1), signaling radio bearer 2 (SRB2), and/or one or more data radio bearers (DRBs) associated with the UE 120, among other examples.

In some aspects, the network node 110 may configure different modes for the HARQ RTT timer associated with an uplink HARQ process, for the PDCCH monitoring timer associated with the uplink HARQ process, and/or for LCP prioritization for the uplink HARQ process. For example, the network node 110 may configure, in the semi-static uplink HARQ process for the uplink HARQ process, the HARQ RTT timer associated with an uplink HARQ process to be enabled (Mode A) and LCP prioritization for the uplink HARQ process to be disabled (Mode B). As another example, the network node 110 may configure, in the semi-static uplink HARQ process for the uplink HARQ process, the HARQ RTT timer associated with an uplink HARQ process to be disabled (Mode B) and LCP prioritization for the uplink HARQ process to be enabled (Mode A).

As further shown in FIG. 7, at 710, the network node 110 may transmit (and the UE 120 may receive) a second downlink communication. The second downlink communication may include a dynamic uplink HARQ configuration for an uplink HARQ process of the plurality of uplink HARQ processes configured for the UE 120. The dynamic uplink HARQ configuration for the uplink HARQ process may at least partially override the semi-static uplink HARQ configuration for the uplink HARQ process.

In some aspects, the dynamic uplink HARQ configuration for the uplink HARQ process may override the HARQ feedback configuration in semi-static uplink HARQ configuration for the uplink HARQ process. For example, the dynamic uplink HARQ configuration may modify the uplink HARQ mode from enabled (Mode A) to disabled (Mode B) for the uplink HARQ process. As another example, the dynamic uplink HARQ configuration may modify the uplink HARQ mode from disabled (Mode B) to enabled (Mode A) for the uplink HARQ process.

In some aspects, the dynamic uplink HARQ configuration for the uplink HARQ process may override the HARQ RTT timer configuration in semi-static uplink HARQ configuration for the uplink HARQ process. For example, the dynamic uplink HARQ configuration may modify the HARQ RTT timer configuration from enabled (Mode A) to disabled (Mode B) for the uplink HARQ process. As another example, the dynamic uplink HARQ configuration may modify the HARQ RTT timer configuration from disabled (Mode B) to enabled (Mode A) for the uplink HARQ process. This enables the network node 110 to schedule a high priority packet using Mode A and/or enables the network node 110 to configure blind retransmissions from the UE 120 before processing HARQ feedback for an uplink transmission, while using the uplink HARQ process primarily for Mode B traffic.

In some aspects, the dynamic uplink HARQ configuration for the uplink HARQ process may override the PDCCH monitoring timer configuration in semi-static uplink HARQ configuration for the uplink HARQ process. For example, the dynamic uplink HARQ configuration may modify the PDCCH monitoring timer configuration from enabled (Mode A) to disabled (Mode B) for the uplink HARQ process. As another example, the dynamic uplink HARQ configuration may modify the PDCCH monitoring timer configuration from disabled (Mode B) to enabled (Mode A) for the uplink HARQ process.

In some aspects, the network node 110 refrains from overriding the LCP configuration for the uplink HARQ process in the semi-static uplink HARQ configuration for the uplink HARQ process. Thus, the LCP prioritization for the uplink HARQ process may be based at least in part on the semi-static uplink HARQ configuration for the uplink HARQ process regardless of the dynamic uplink HARQ configuration for the uplink HARQ process. For blind retransmissions, using a dynamic uplink HARQ configuration to override the LCP configuration may result in the UE 120 and the network node 110 becoming out of sync if the dynamic uplink HARQ configuration is missed by the UE 120.

The second downlink communication may include a DCI communication and/or another type of downlink communication. The DCI communication may include one or more new bits that are dedicated for indicating whether the uplink HARQ mode for the uplink HARQ process is disabled or enabled, one or more new bits that are dedicated for indicating whether the HARQ RTT timer for the uplink HARQ process is disabled or enabled, and/or one or more new bits for indicating whether the PDCCH monitoring timer for the uplink HARQ process is disabled or enabled.

As further shown in FIG. 7, at 715, the UE 120 and the network node 110 may communicate based at least in part on the dynamic uplink HARQ configuration. For example, the dynamic uplink HARQ configuration may indicate that the uplink HARQ mode for an uplink HARQ process is modified from disabled (Mode B) to enabled (Mode A), and the UE 120 and the network node 110 may implement HARQ for an associated uplink transmission. Moreover, the network node 110 may initiate a HARQ RTT timer based at least in part on the dynamic uplink HARQ configuration indicating that the uplink HARQ process is modified from disabled to enabled. Moreover, the network node 110 may initiate a PDCCH monitoring timer based at least in part on the dynamic uplink HARQ configuration indicating that the uplink HARQ process is modified from disabled to enabled.

As another example, the dynamic uplink HARQ configuration may indicate that an uplink HARQ mode for an uplink HARQ process is modified from enabled (Mode A) to disabled (Mode B), and the UE 120 and the network node 110 may refrain from implementing HARQ for an associated uplink transmission. Moreover, the network node 110 may refrain from initiating a HARQ RTT timer based at least in part on the dynamic uplink HARQ configuration indicating that the uplink HARQ process is modified from enabled to disabled. Moreover, the network node 110 may refrain from initiating a PDCCH monitoring timer based at least in part on the dynamic uplink HARQ configuration indicating that the uplink HARQ process is modified from enabled to disabled.

Additionally and/or alternatively, the UE 120 and the network node 110 may communicate based at least in part on a semi-static uplink HARQ configuration for an uplink HARQ process that is associated with an uplink transmission. For example, the dynamic uplink HARQ configuration may only affect or override the HARQ feedback configuration (e.g., whether the uplink HARQ mode for the uplink HARQ process is disabled or enabled), the HARQ RTT timer configuration (e.g., whether the HARQ RTT timer is disabled or enabled) for the uplink HARQ process, and/or the PDCCH monitoring timer configuration (e.g., whether the PDCCH monitoring timer is disabled or enabled) for the uplink HARQ process. However, the UE 120 and the network node 110 may communicate based at least in part on the LCP configuration in the semi-static uplink HARQ configuration for the uplink HARQ process that is associated with the uplink transmission (e.g., regardless of the dynamic uplink HARQ configuration). Thus, if LCP prioritization is enabled (Mode A) in the semi-static uplink HARQ configuration, the UE 120 and the network node 110 may use LCP prioritization for the uplink transmission. Conversely, if LCP is disabled (Mode B) in the semi-static uplink HARQ configuration, the UE 120 and the network node 110 may refrain from using LCP for the uplink transmission.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with dynamically overriding a HARQ feedback configuration.

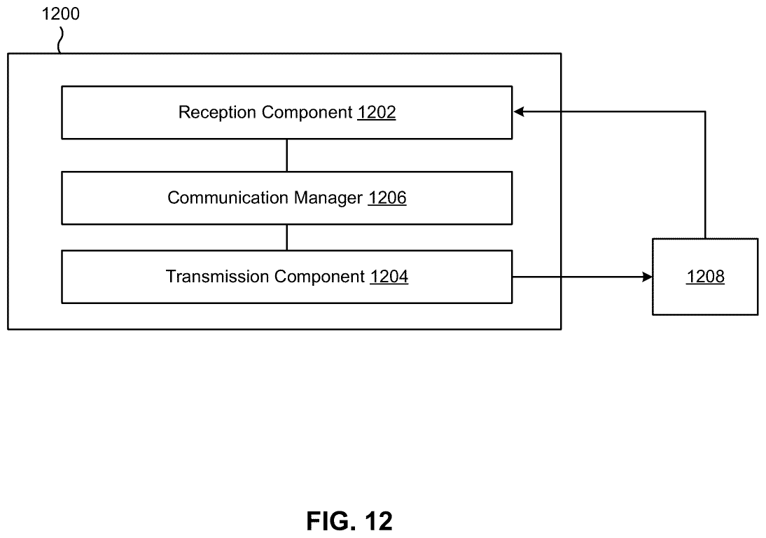

As shown in FIG. 8, in some aspects, process 800 may include receiving an RRC configuration that indicates that HARQ feedback associated with a downlink HARQ process is disabled or enabled (block 810). For example, the UE (e.g., using reception component 1202 and/or communication manager 1206, depicted in FIG. 12) may receive an RRC configuration that indicates that HARQ feedback associated with a downlink HARQ process is disabled or enabled, as described above.

As further shown in FIG. 8, in some aspects, process 800 may include receiving a DCI communication that overrides the RRC configuration (block 820). For example, the UE (e.g., using reception component 1202 and/or communication manager 1206, depicted in FIG. 12) may receive a DCI communication that overrides the RRC configuration, as described above.

As further shown in FIG. 8, in some aspects, process 800 may include selectively transmitting HARQ feedback, associated with the downlink HARQ process, for a downlink transmission based at least in part on the DCI communication (block 830). For example, the UE (e.g., using transmission component 1204 and/or communication manager 1206, depicted in FIG. 12) may selectively transmit HARQ feedback, associated with the downlink HARQ process, for a downlink transmission based at least in part on the DCI communication, as described above.

As further shown in FIG. 8, in some aspects, process 800 may include selectively initiating, based at least in part on selectively transmitting the HARQ feedback, PDCCH monitoring associated with the downlink HARQ process based at least in part on at least one of the RRC configuration or the DCI communication (block 840). For example, the UE (e.g., using communication manager 1206, depicted in FIG. 12) may selectively initiate, based at least in part on selectively transmitting the HARQ feedback, PDCCH monitoring associated with the downlink HARQ process based at least in part on at least one of the RRC configuration or the DCI communication, as described above.

Process 800 may include additional aspects, such as any single aspect or any combination of aspects described below and/or in connection with one or more other processes described elsewhere herein.

In a first aspect, the RRC configuration indicates that HARQ feedback associated with the downlink HARQ process is enabled, and the DCI communication overrides the RRC configuration and indicates, in a HARQ resource field in the DCI communication, that HARQ feedback associated with the downlink HARQ process is disabled.

In a second aspect, alone or in combination with the first aspect, the RRC configuration indicates that HARQ feedback associated with the downlink HARQ process is enabled, and the DCI communication overrides the RRC configuration and indicates, in a HARQ resource offset field in the DCI communication, that HARQ feedback associated with the downlink HARQ process is disabled.

In a third aspect, alone or in combination with one or more of the first and second aspects, the RRC configuration indicates that HARQ feedback associated with the downlink HARQ process is disabled, wherein the DCI communication overrides the RRC configuration and indicates that HARQ feedback associated with the downlink HARQ process is enabled, and selectively transmitting the HARQ feedback, associated with the downlink HARQ process, for the downlink transmission comprises transmitting the HARQ feedback, associated with the downlink HARQ process, for the downlink transmission based at least in part on the DCI communication indicating that HARQ feedback associated with the downlink HARQ process is enabled.

In a fourth aspect, alone or in combination with one or more of the first through third aspects, the RRC configuration indicates, in a HARQ resource field in the DCI communication, that HARQ feedback associated with the downlink HARQ process is disabled.

In a fifth aspect, alone or in combination with one or more of the first through fourth aspects, the RRC configuration indicates, in a HARQ resource offset field in the DCI communication, that HARQ feedback associated with the downlink HARQ process is disabled.

In a sixth aspect, alone or in combination with one or more of the first through fifth aspects, the RRC configuration indicates that a HARQ round-trip time (RTT) timer associated with the downlink HARQ process is disabled, and selectively initiating PDCCH monitoring associated with the downlink HARQ process comprises refraining from initiating the HARQ RTT timer based at least in part on the RRC configuration indicating that the HARQ RTT timer associated with the downlink HARQ process is disabled.

In a seventh aspect, alone or in combination with one or more of the first through sixth aspects, the RRC configuration indicates that a HARQ round-trip time (RTT) timer associated with the downlink HARQ process is enabled, and selectively initiating PDCCH monitoring associated with the downlink HARQ process comprises initiating the HARQ RTT timer based at least in part on the RRC configuration indicating that the HARQ RTT timer associated with the downlink HARQ process is enabled.

In an eighth aspect, alone or in combination with one or more of the first through seventh aspects, process 800 includes initiating a discontinuous reception (DRX) timer based at least in part on expiration of the HARQ RTT timer.

In a ninth aspect, alone or in combination with one or more of the first through eighth aspects, the RRC configuration comprises a first field indicating that HARQ feedback associated with the downlink HARQ process is disabled or enabled, and a second field indicating whether a HARQ RTT timer associated with the downlink HARQ process is disabled or enabled.

In a tenth aspect, alone or in combination with one or more of the first through ninth aspects, the DCI communication comprises a first field indicating that HARQ feedback associated with the downlink HARQ process is disabled or enabled, and a second field indicating whether a HARQ RTT timer associated with the downlink HARQ process is disabled or enabled.

In an eleventh aspect, alone or in combination with one or more of the first through tenth aspects, selectively initiating PDCCH monitoring comprises selectively initiating, based at least in part on selectively transmitting the HARQ feedback, a HARQ RTT timer based at least in part on whether a HARQ process identifier bitmap is included in the RRC configuration.

In a twelfth aspect, alone or in combination with one or more of the first through eleventh aspects, the HARQ process identifier bitmap is indicative of whether HARQ feedback is enabled or disabled for a set of HARQ process identifiers.

In a thirteenth aspect, alone or in combination with one or more of the first through twelfth aspects, selectively initiating PDCCH monitoring comprises selectively initiating, based at least in part on selectively transmitting the HARQ feedback, a HARQ RTT timer based at least in part on whether at least one of one or more downlink HARQ processes, including the downlink HARQ process, is enabled for the UE.

In a fourteenth aspect, alone or in combination with one or more of the first through thirteenth aspects, selectively initiating PDCCH monitoring comprises selectively initiating, based at least in part on selectively transmitting the HARQ feedback, a HARQ RTT timer based at least in part on whether at least one of one or more downlink HARQ processes, including the downlink HARQ process, is enabled in the RRC configuration.

In a fifteenth aspect, alone or in combination with one or more of the first through fourteenth aspects, selectively initiating PDCCH monitoring comprises selectively initiating, based at least in part on selectively transmitting the HARQ feedback, a HARQ RTT timer based at least in part on a quantity of downlink HARQ processes, including the downlink HARQ process, that is enabled for the UE.

In a sixteenth aspect, alone or in combination with one or more of the first through fifteenth aspects, the RRC configuration indicates that a PDCCH monitoring timer associated with the downlink HARQ process is disabled, and selectively initiating PDCCH monitoring associated with the downlink HARQ process comprises refraining from initiating the PDCCH monitoring timer based at least in part on the RRC configuration indicating that the PDCCH monitoring timer associated with the downlink HARQ process is disabled.

In a seventeenth aspect, alone or in combination with one or more of the first through sixteenth aspects, the RRC configuration indicates that a PDCCH monitoring timer associated with the downlink HARQ process is enabled, and selectively initiating PDCCH monitoring associated with the downlink HARQ process comprises initiating the PDCCH monitoring timer based at least in part on the RRC configuration indicating that the PDCCH monitoring timer associated with the downlink HARQ process is enabled.

In an eighteenth aspect, alone or in combination with one or more of the first through seventeenth aspects, the RRC configuration comprises a first field indicating that HARQ feedback associated with the downlink HARQ process is disabled or enabled, and a second field indicating whether a PDCCH monitoring timer associated with the downlink HARQ process is disabled or enabled.

In a nineteenth aspect, alone or in combination with one or more of the first through eighteenth aspects, the DCI communication comprises a first field indicating that HARQ feedback associated with the downlink HARQ process is disabled or enabled, and a second field indicating whether a PDCCH monitoring timer associated with the downlink HARQ process is disabled or enabled.

In a twentieth aspect, alone or in combination with one or more of the first through nineteenth aspects, selectively initiating PDCCH monitoring comprises selectively initiating, based at least in part on selectively transmitting the HARQ feedback, a PDCCH monitoring timer based at least in part on whether a HARQ process identifier bitmap is included in the RRC configuration.

In a twenty-first aspect, alone or in combination with one or more of the first through twentieth aspects, selectively initiating PDCCH monitoring comprises selectively initiating, based at least in part on selectively transmitting the HARQ feedback, a PDCCH monitoring timer based at least in part on whether at least one of one or more downlink HARQ processes, including the downlink HARQ process, is enabled for the UE.

In a twenty-second aspect, alone or in combination with one or more of the first through twenty-first aspects, selectively initiating PDCCH monitoring comprises selectively initiating, based at least in part on selectively transmitting the HARQ feedback, a PDCCH monitoring timer based at least in part on whether at least one of one or more downlink HARQ processes, including the downlink HARQ process, is enabled in the RRC configuration.

In a twenty-third aspect, alone or in combination with one or more of the first through twenty-second aspects, selectively initiating PDCCH monitoring comprises selectively initiating, based at least in part on selectively transmitting the HARQ feedback, a PDCCH monitoring timer based at least in part on a quantity of downlink HARQ processes, including the downlink HARQ process, that is enabled for the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with dynamically overriding a HARQ feedback configuration.

As shown in FIG. 9, in some aspects, process 900 may include receiving a first downlink communication that includes a respective semi-static uplink HARQ configuration for each of a plurality of uplink HARQ processes associated with the UE, wherein the respective semi-static uplink HARQ configurations indicate whether an uplink HARQ mode is enabled or disabled for each of the plurality of uplink HARQ processes (block 910). For example, the UE (e.g., using reception component 1202 and/or communication manager 1206, depicted in FIG. 12) may receive a first downlink communication that includes a respective semi-static uplink HARQ configuration for each of a plurality of uplink HARQ processes associated with the UE, wherein the respective semi-static uplink HARQ configurations indicate whether an uplink HARQ mode is enabled or disabled for each of the plurality of uplink HARQ processes, as described above. In some aspects, the respective semi-static uplink HARQ configurations indicate whether an uplink HARQ mode is enabled or disabled for each of the plurality of uplink HARQ processes.

As further shown in FIG. 9, in some aspects, process 900 may include receiving a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process (block 920). For example, the UE (e.g., using reception component 1202 and/or communication manager 1206, depicted in FIG. 12) may receive a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process, as described above. In some aspects, the dynamic uplink HARQ configuration at least partially overrides a semi-static uplink HARQ configuration, indicated in the first downlink communication, associated with the uplink HARQ process.

Process 900 may include additional aspects, such as any single aspect or any combination of aspects described below and/or in connection with one or more other processes described elsewhere herein.

In a first aspect, the first downlink communication comprises an RRC communication, and the second downlink communication comprises a DCI communication.

In a second aspect, alone or in combination with the first aspect, the dynamic uplink HARQ configuration includes a dynamic HARQ RTT timer configuration that overrides a semi-static HARQ RTT timer configuration included in the semi-static uplink HARQ configuration for the uplink HARQ process.

In a third aspect, alone or in combination with one or more of the first and second aspects, the dynamic uplink HARQ configuration is indicated by one or more bits included in a field in the second downlink communication, and the field is dedicated for indicating the dynamic uplink HARQ configuration.

In a fourth aspect, alone or in combination with one or more of the first through third aspects, an LCP prioritization is based at least in part on a semi-static uplink HARQ configuration, in the first downlink communication, for the uplink HARQ process regardless of the dynamic uplink HARQ configuration for the uplink HARQ process.

In a fifth aspect, alone or in combination with one or more of the first through fourth aspects, the dynamic uplink HARQ configuration includes a dynamic PDCCH monitoring timer configuration that overrides a semi-static PDCCH monitoring timer configuration included in the semi-static uplink HARQ configuration for the uplink HARQ process.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

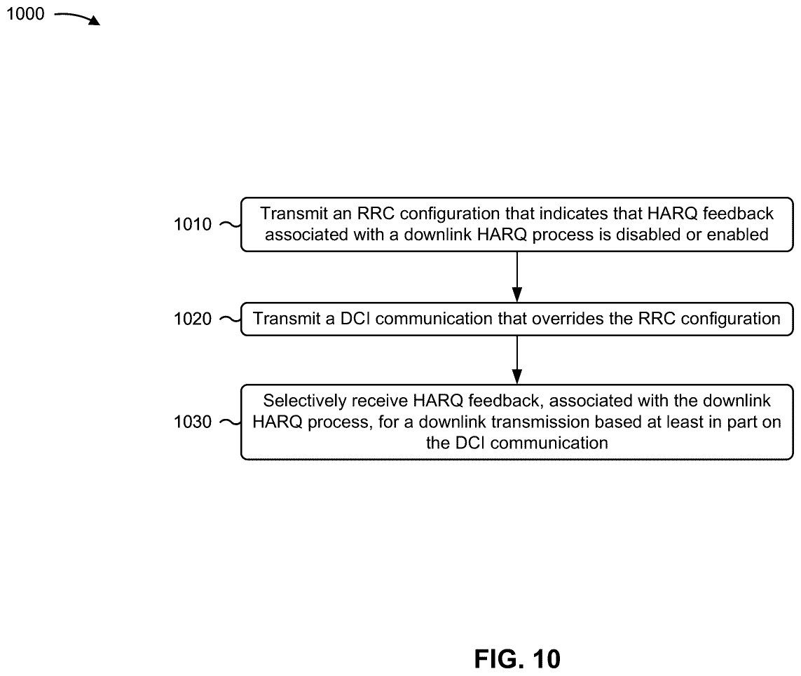

FIG. 10 is a diagram illustrating an example process 1000 performed, for example, by a network node, in accordance with the present disclosure. Example process 1000 is an example where the network node (e.g., network node 110) performs operations associated with dynamically overriding a HARQ feedback configuration.

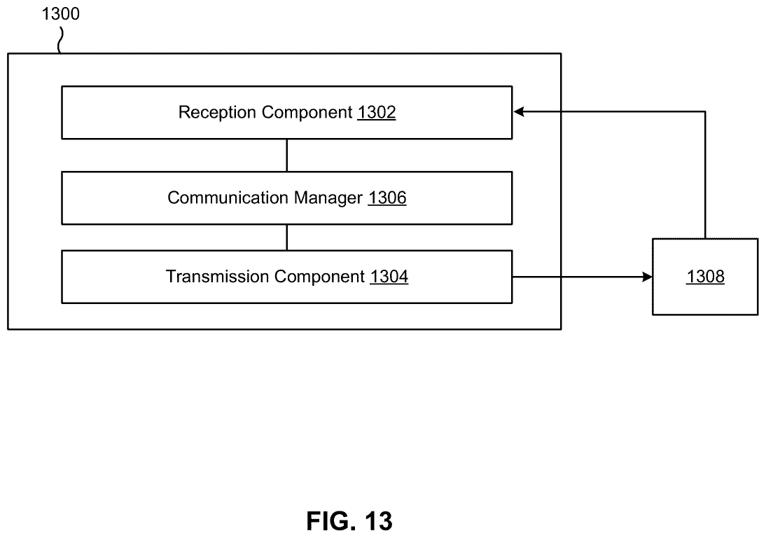

As shown in FIG. 10, in some aspects, process 1000 may include transmitting an RRC configuration that indicates that HARQ feedback associated with a downlink HARQ process is disabled or enabled (block 1010). For example, the network node (e.g., using transmission component 1304 and/or communication manager 1306, depicted in FIG. 13) may transmit an RRC configuration that indicates that HARQ feedback associated with a downlink HARQ process is disabled or enabled, as described above.

As further shown in FIG. 10, in some aspects, process 1000 may include transmitting a DCI communication that overrides the RRC configuration (block 1020). For example, the network node (e.g., using transmission component 1304 and/or communication manager 1306, depicted in FIG. 13) may transmit a DCI communication that overrides the RRC configuration, as described above.

As further shown in FIG. 10, in some aspects, process 1000 may include selectively receiving HARQ feedback, associated with the downlink HARQ process, for a downlink transmission based at least in part on the DCI communication (block 1030). For example, the network node (e.g., using reception component 1302 and/or communication manager 1306, depicted in FIG. 13) may selectively receive HARQ feedback, associated with the downlink HARQ process, for a downlink transmission based at least in part on the DCI communication, as described above.

Process 1000 may include additional aspects, such as any single aspect or any combination of aspects described below and/or in connection with one or more other processes described elsewhere herein.

In a first aspect, the RRC configuration indicates that HARQ feedback associated with the downlink HARQ process is enabled, and the DCI communication overrides the RRC configuration and indicates, in a HARQ resource field in the DCI communication, that HARQ feedback associated with the downlink HARQ process is disabled.

In a second aspect, alone or in combination with the first aspect, the RRC configuration indicates that HARQ feedback associated with the downlink HARQ process is enabled, and the DCI communication overrides the RRC configuration and indicates, in a HARQ resource offset field in the DCI communication, that HARQ feedback associated with the downlink HARQ process is disabled.

In a third aspect, alone or in combination with one or more of the first and second aspects, the RRC configuration indicates that HARQ feedback associated with the downlink HARQ process is disabled, wherein the DCI communication overrides the RRC configuration and indicates that HARQ feedback associated with the downlink HARQ process is enabled, and selectively receiving the HARQ feedback, associated with the downlink HARQ process, for the downlink transmission comprises receiving the HARQ feedback, associated with the downlink HARQ process, for the downlink transmission based at least in part on the DCI communication indicating that HARQ feedback associated with the downlink HARQ process is enabled.

In a fourth aspect, alone or in combination with one or more of the first through third aspects, the RRC configuration indicates, in a HARQ resource field in the DCI communication, that HARQ feedback associated with the downlink HARQ process is disabled.

In a fifth aspect, alone or in combination with one or more of the first through fourth aspects, the RRC configuration indicates, in a HARQ resource offset field in the DCI communication, that HARQ feedback associated with the downlink HARQ process is disabled.

In a sixth aspect, alone or in combination with one or more of the first through fifth aspects, the RRC configuration indicates that a HARQ RTT timer associated with the downlink HARQ process is disabled or enabled.

In a seventh aspect, alone or in combination with one or more of the first through sixth aspects, the RRC configuration comprises a first field indicating that HARQ feedback associated with the downlink HARQ process is disabled or enabled, and a second field indicating whether a HARQ RTT timer associated with the downlink HARQ process is disabled or enabled.

In an eighth aspect, alone or in combination with one or more of the first through seventh aspects, the DCI communication comprises a first field indicating that HARQ feedback associated with the downlink HARQ process is disabled or enabled, and a second field indicating whether a HARQ RTT timer associated with the downlink HARQ process is disabled or enabled.

In a ninth aspect, alone or in combination with one or more of the first through eighth aspects, the RRC configuration indicates that a PDCCH monitoring timer associated with the downlink HARQ process is disabled or enabled.

In a tenth aspect, alone or in combination with one or more of the first through ninth aspects, the RRC configuration comprises a first field indicating that HARQ feedback associated with the downlink HARQ process is disabled or enabled, and a second field indicating whether a PDCCH monitoring timer associated with the downlink HARQ process is disabled or enabled.

In an eleventh aspect, alone or in combination with one or more of the first through tenth aspects, the DCI communication comprises a first field indicating that HARQ feedback associated with the downlink HARQ process is disabled or enabled, and a second field indicating whether a PDCCH monitoring timer associated with the downlink HARQ process is disabled or enabled.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with dynamically overriding a HARQ feedback configuration.

As shown in FIG. 11, in some aspects, process 1100 may include transmitting a first downlink communication that includes a respective semi-static uplink HARQ configuration for each of a plurality of uplink HARQ processes associated with a UE, wherein the respective semi-static uplink HARQ configurations indicate whether an uplink HARQ mode is enabled or disabled for each of the plurality of uplink HARQ processes (block 1110). For example, the network node (e.g., using transmission component 1304 and/or communication manager 1306, depicted in FIG. 13) may transmit a first downlink communication that includes a respective semi-static uplink HARQ configuration for each of a plurality of uplink HARQ processes associated with a UE, wherein the respective semi-static uplink HARQ configurations indicate whether an uplink HARQ mode is enabled or disabled for each of the plurality of uplink HARQ processes, as described above. In some aspects, the respective semi-static uplink HARQ configurations indicate whether an uplink HARQ mode is enabled or disabled for each of the plurality of uplink HARQ processes.

As further shown in FIG. 11, in some aspects, process 1100 may include transmitting a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process (block 1120). For example, the network node (e.g., using transmission component 1304 and/or communication manager 1306, depicted in FIG. 13) may transmit a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process, as described above. In some aspects, the dynamic uplink HARQ configuration at least partially overrides a semi-static uplink HARQ configuration, indicated in the first downlink communication, associated with the uplink HARQ process.

Process 1100 may include additional aspects, such as any single aspect or any combination of aspects described below and/or in connection with one or more other processes described elsewhere herein.

In a first aspect, the first downlink communication comprises an RRC communication, and the second downlink communication comprises a DCI communication.

In a second aspect, alone or in combination with the first aspect, the dynamic uplink HARQ configuration includes a dynamic HARQ RTT timer configuration that overrides a semi-static HARQ RTT timer configuration included in the semi-static uplink HARQ configuration for the uplink HARQ process.

In a third aspect, alone or in combination with one or more of the first and second aspects, the dynamic uplink HARQ configuration is indicated by one or more bits included in a field in the second downlink communication, and the field is dedicated for indicating the dynamic uplink HARQ configuration.

In a fourth aspect, alone or in combination with one or more of the first through third aspects, an LCP prioritization is based at least in part on a semi-static uplink HARQ configuration, in the first downlink communication, for the uplink HARQ process regardless of the dynamic uplink HARQ configuration for the uplink HARQ process.

In a fifth aspect, alone or in combination with one or more of the first through fourth aspects, wherein the dynamic uplink HARQ configuration includes a dynamic PDCCH monitoring timer configuration that overrides a semi-static PDCCH monitoring timer configuration included in the semi-static uplink HARQ configuration for the uplink HARQ process.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5A, 5B, 6A-6C, and/or 7. Additionally, or alternatively, the apparatus 1200 may be configured to perform one or more processes described herein, such as process 800 of FIG. 8, process 900 of FIG. 9, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive (e.g., from the apparatus 1208) an RRC configuration that indicates that HARQ feedback associated with a downlink HARQ process is disabled or enabled. The reception component 1202 may receive (e.g., from the apparatus 1208) a DCI communication that overrides the RRC configuration. The transmission component 1204 may selectively transmit (e.g., to the apparatus 1208) HARQ feedback, associated with the downlink HARQ process, for a downlink transmission based at least in part on the DCI communication. The communication manager 1206 may selectively initiate, based at least in part on selectively transmitting the HARQ feedback, PDCCH monitoring associated with the downlink HARQ process based at least in part on at least one of the RRC configuration or the DCI communication.

The reception component 1202 may receive (e.g., from the apparatus 1208) a first downlink communication that includes a respective semi-static uplink HARQ configuration for each of a plurality of uplink HARQ processes associated with the apparatus 1200, wherein the respective semi-static uplink HARQ configurations indicate whether an uplink HARQ mode is enabled or disabled for each of the plurality of uplink HARQ processes. The reception component 1202 may receive (e.g., from the apparatus 1208) a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 5A, 5B, 6A-6C, and/or 7. Additionally, or alternatively, the apparatus 1300 may be configured to perform one or more processes described herein, such as process 1000 of FIG. 10, process 1100 of FIG. 11, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit (e.g., to the apparatus 1308) an RRC configuration that indicates that HARQ feedback associated with a downlink HARQ process is disabled or enabled. The transmission component 1304 may transmit (e.g., to the apparatus 1308) a DCI communication that overrides the RRC configuration. The reception component 1302 may selectively receive (e.g., from the apparatus 1308) HARQ feedback, associated with the downlink HARQ process, for a downlink transmission based at least in part on the DCI communication.

The transmission component 1304 may transmit (e.g., to the apparatus 1308) a first downlink communication that includes a respective semi-static uplink HARQ configuration for each of a plurality of uplink HARQ processes associated with the apparatus 1308, wherein the respective semi-static uplink HARQ configurations indicate whether an uplink HARQ mode is enabled or disabled for each of the plurality of uplink HARQ processes. The transmission component 1304 may transmit (e.g., to the apparatus 1308) a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a radio resource control (RRC) configuration that indicates that hybrid automatic repeat request (HARQ) feedback associated with a downlink HARQ process is disabled or enabled; receiving a downlink control information (DCI) communication that overrides the RRC configuration; selectively transmitting HARQ feedback, associated with the downlink HARQ process, for a downlink transmission based at least in part on the DCI communication; and selectively initiating, based at least in part on selectively transmitting the HARQ feedback, physical downlink control channel (PDCCH) monitoring associated with the downlink HARQ process based at least in part on at least one of the RRC configuration or the DCI communication.

Aspect 2: The method of Aspect 1, wherein the RRC configuration indicates that HARQ feedback associated with the downlink HARQ process is enabled; and wherein the DCI communication overrides the RRC configuration and indicates, in a HARQ resource field in the DCI communication, that HARQ feedback associated with the downlink HARQ process is disabled.

Aspect 3: The method of any of Aspects 1-2, wherein the RRC configuration indicates that HARQ feedback associated with the downlink HARQ process is enabled; and wherein the DCI communication overrides the RRC configuration and indicates, in a HARQ resource offset field in the DCI communication, that HARQ feedback associated with the downlink HARQ process is disabled.

Aspect 4: The method of any of Aspects 1-3, wherein the RRC configuration indicates that HARQ feedback associated with the downlink HARQ process is disabled; wherein the DCI communication overrides the RRC configuration and indicates that HARQ feedback associated with the downlink HARQ process is enabled; and wherein selectively transmitting the HARQ feedback, associated with the downlink HARQ process, for the downlink transmission comprises: transmitting the HARQ feedback, associated with the downlink HARQ process, for the downlink transmission based at least in part on the DCI communication indicating that HARQ feedback associated with the downlink HARQ process is enabled.

Aspect 5: The method of any of Aspects 1-4, wherein the RRC configuration indicates, in a HARQ resource field in the DCI communication, that HARQ feedback associated with the downlink HARQ process is disabled.

Aspect 6: The method of any of Aspects 1-5, wherein the RRC configuration indicates, in a HARQ resource offset field in the DCI communication, that HARQ feedback associated with the downlink HARQ process is disabled.

Aspect 7: The method of any of Aspects 1-6, wherein the RRC configuration indicates that a HARQ round-trip time (RTT) timer associated with the downlink HARQ process is disabled; and wherein selectively initiating PDCCH monitoring associated with the downlink HARQ process comprises: refraining from initiating the HARQ RTT timer based at least in part on the RRC configuration indicating that the HARQ RTT timer associated with the downlink HARQ process is disabled.

Aspect 8: The method of any of Aspects 1-7, wherein the RRC configuration indicates that a HARQ round-trip time (RTT) timer associated with the downlink HARQ process is enabled; and wherein selectively initiating PDCCH monitoring associated with the downlink HARQ process comprises: initiating the HARQ RTT timer based at least in part on the RRC configuration indicating that the HARQ RTT timer associated with the downlink HARQ process is enabled.

Aspect 9: The method of Aspect 8, further comprising: initiating a discontinuous reception (DRX) timer based at least in part on expiration of the HARQ RTT timer.

Aspect 10: The method of any of Aspects 1-9, wherein the RRC configuration comprises: a first field indicating that HARQ feedback associated with the downlink HARQ process is disabled or enabled; and a second field indicating whether a HARQ round-trip time (RTT) timer associated with the downlink HARQ process is disabled or enabled.

Aspect 11: The method of any of Aspects 1-10, wherein the DCI communication comprises: a first field indicating that HARQ feedback associated with the downlink HARQ process is disabled or enabled; and a second field indicating whether a HARQ round-trip time (RTT) timer associated with the downlink HARQ process is disabled or enabled.

Aspect 12: The method of any of Aspects 1-11, wherein selectively initiating PDCCH monitoring comprises: selectively initiating, based at least in part on selectively transmitting the HARQ feedback, a HARQ round-trip time (RTT) timer based at least in part on whether a HARQ process identifier bitmap is included in the RRC configuration.

Aspect 13: The method of Aspect 12, wherein the HARQ process identifier bitmap is indicative of whether HARQ feedback is enabled or disabled for a set of HARQ process identifiers.

Aspect 14: The method of any of Aspects 1-13, wherein selectively initiating PDCCH monitoring comprises: selectively initiating, based at least in part on selectively transmitting the HARQ feedback, a HARQ round-trip time (RTT) timer based at least in part on whether at least one of one or more downlink HARQ processes, including the downlink HARQ process, is enabled for the UE.

Aspect 15: The method of any of Aspects 1-14, wherein selectively initiating PDCCH monitoring comprises: selectively initiating, based at least in part on selectively transmitting the HARQ feedback, a HARQ round-trip time (RTT) timer based at least in part on whether at least one of one or more downlink HARQ processes, including the downlink HARQ process, is enabled in the RRC configuration.

Aspect 16: The method of any of Aspects 1-15, wherein selectively initiating PDCCH monitoring comprises: selectively initiating, based at least in part on selectively transmitting the HARQ feedback, a HARQ round-trip time (RTT) timer based at least in part on a quantity of downlink HARQ processes, including the downlink HARQ process, that is enabled for the UE.

Aspect 17: The method of any of Aspects 1-16, wherein the RRC configuration indicates that a PDCCH monitoring timer associated with the downlink HARQ process is disabled; and wherein selectively initiating PDCCH monitoring associated with the downlink HARQ process comprises: refraining from initiating the PDCCH monitoring timer based at least in part on the RRC configuration indicating that the PDCCH monitoring timer associated with the downlink HARQ process is disabled.

Aspect 18: The method of any of Aspects 1-17, wherein the RRC configuration indicates that a PDCCH monitoring timer associated with the downlink HARQ process is enabled; and wherein selectively initiating PDCCH monitoring associated with the downlink HARQ process comprises: initiating the PDCCH monitoring timer based at least in part on the RRC configuration indicating that the PDCCH monitoring timer associated with the downlink HARQ process is enabled.

Aspect 19: The method of any of Aspects 1-18, wherein the RRC configuration comprises: a first field indicating that HARQ feedback associated with the downlink HARQ process is disabled or enabled; and a second field indicating whether a PDCCH monitoring timer associated with the downlink HARQ process is disabled or enabled.

Aspect 20: The method of any of Aspects 1-19, wherein the DCI communication comprises: a first field indicating that HARQ feedback associated with the downlink HARQ process is disabled or enabled; and a second field indicating whether a PDCCH monitoring timer associated with the downlink HARQ process is disabled or enabled.

Aspect 21: The method of any of Aspects 1-20, wherein selectively initiating PDCCH monitoring comprises: selectively initiating, based at least in part on selectively transmitting the HARQ feedback, a PDCCH monitoring timer based at least in part on whether a HARQ process identifier bitmap is included in the RRC configuration.

Aspect 22: The method of any of Aspects 1-21, wherein selectively initiating PDCCH monitoring comprises: selectively initiating, based at least in part on selectively transmitting the HARQ feedback, a PDCCH monitoring timer based at least in part on whether at least one of one or more downlink HARQ processes, including the downlink HARQ process, is enabled for the UE.

Aspect 23: The method of any of Aspects 1-22, wherein selectively initiating PDCCH monitoring comprises: selectively initiating, based at least in part on selectively transmitting the HARQ feedback, a PDCCH monitoring timer based at least in part on whether at least one of one or more downlink HARQ processes, including the downlink HARQ process, is enabled in the RRC configuration.

Aspect 24: The method of any of Aspects 1-23, wherein selectively initiating PDCCH monitoring comprises: selectively initiating, based at least in part on selectively transmitting the HARQ feedback, a PDCCH monitoring timer based at least in part on a quantity of downlink HARQ processes, including the downlink HARQ process, that is enabled for the UE.

Aspect 25: A method of wireless communication performed by a user equipment (UE), comprising: receiving a first downlink communication that includes a respective semi-static uplink hybrid automatic repeat request (HARQ) configuration for each of a plurality of uplink HARQ processes associated with the UE, wherein the respective semi-static uplink HARQ configurations indicate whether an uplink HARQ mode is enabled or disabled for each of the plurality of uplink HARQ processes; and receiving a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process.

Aspect 26: The method of Aspect 25, wherein the first downlink communication comprises a radio resource control (RRC) communication; and wherein the second downlink communication comprises a downlink control information (DCI) communication.

Aspect 27: The method of any of Aspects 25-26, wherein the dynamic uplink HARQ configuration includes a dynamic HARQ round-trip time (RTT) timer configuration that overrides a semi-static HARQ RTT timer configuration included in the semi-static uplink HARQ configuration for the uplink HARQ process.

Aspect 28: The method of any of Aspects 25-27, wherein the dynamic uplink HARQ configuration is indicated by one or more bits included in a field in the second downlink communication; and wherein the field is dedicated for indicating the dynamic uplink HARQ configuration.

Aspect 29: The method of any of Aspects 25-28, wherein a logical channel priority (LCP) prioritization is based at least in part on a semi-static uplink HARQ configuration, in the first downlink communication, for the uplink HARQ process regardless of the dynamic uplink HARQ configuration for the uplink HARQ process.

Aspect 30: The method of Aspect 25-29, wherein the dynamic uplink HARQ configuration includes a dynamic physical downlink control channel (PDCCH) monitoring timer configuration that overrides a semi-static PDCCH monitoring timer configuration included in the semi-static uplink HARQ configuration for the uplink HARQ process.

Aspect 31: A method of wireless communication performed by a network node, comprising: transmitting a radio resource control (RRC) configuration that indicates that hybrid automatic repeat request (HARQ) feedback associated with a downlink HARQ process is disabled or enabled; transmitting a downlink control information (DCI) communication that overrides the RRC configuration; and selectively receiving HARQ feedback, associated with the downlink HARQ process, for a downlink transmission based at least in part on the DCI communication.

Aspect 32: The method of Aspect 31, wherein the RRC configuration indicates that HARQ feedback associated with the downlink HARQ process is enabled; and wherein the DCI communication overrides the RRC configuration and indicates, in a HARQ resource field in the DCI communication, that HARQ feedback associated with the downlink HARQ process is disabled.

Aspect 33: The method of any of Aspects 31-32, wherein the RRC configuration indicates that HARQ feedback associated with the downlink HARQ process is enabled; and wherein the DCI communication overrides the RRC configuration and indicates, in a HARQ resource offset field in the DCI communication, that HARQ feedback associated with the downlink HARQ process is disabled.

Aspect 34: The method of any of Aspects 31-33, wherein the RRC configuration indicates that HARQ feedback associated with the downlink HARQ process is disabled; wherein the DCI communication overrides the RRC configuration and indicates that HARQ feedback associated with the downlink HARQ process is enabled; and wherein selectively receiving the HARQ feedback, associated with the downlink HARQ process, for the downlink transmission comprises: receiving the HARQ feedback, associated with the downlink HARQ process, for the downlink transmission based at least in part on the DCI communication indicating that HARQ feedback associated with the downlink HARQ process is enabled.

Aspect 35: The method of any of Aspects 31-34, wherein the RRC configuration indicates, in a HARQ resource field in the DCI communication, that HARQ feedback associated with the downlink HARQ process is disabled.

Aspect 36: The method of any of Aspects 31-35, wherein the RRC configuration indicates, in a HARQ resource offset field in the DCI communication, that HARQ feedback associated with the downlink HARQ process is disabled.

Aspect 37: The method of any of Aspects 31-36, wherein the RRC configuration indicates that a HARQ round-trip time (RTT) timer associated with the downlink HARQ process is disabled or enabled.

Aspect 38: The method of any of Aspects 31-37, wherein the RRC configuration comprises: a first field indicating that HARQ feedback associated with the downlink HARQ process is disabled or enabled; and a second field indicating whether a HARQ round-trip time (RTT) timer associated with the downlink HARQ process is disabled or enabled.

Aspect 39: The method of any of Aspects 31-38, wherein the DCI communication comprises: a first field indicating that HARQ feedback associated with the downlink HARQ process is disabled or enabled; and a second field indicating whether a HARQ round-trip time (RTT) timer associated with the downlink HARQ process is disabled or enabled.

Aspect 40: The method of any of Aspects 31-39, wherein the RRC configuration indicates that a physical downlink control channel (PDCCH) monitoring timer associated with the downlink HARQ process is disabled or enabled.

Aspect 41: The method of any of Aspects 31-40, wherein the RRC configuration comprises: a first field indicating that HARQ feedback associated with the downlink HARQ process is disabled or enabled; and a second field indicating whether a physical downlink control channel (PDCCH) monitoring timer associated with the downlink HARQ process is disabled or enabled.

Aspect 42: The method of any of Aspects 31-41, wherein the DCI communication comprises: a first field indicating that HARQ feedback associated with the downlink HARQ process is disabled or enabled; and a second field indicating whether a physical downlink control channel (PDCCH) monitoring timer associated with the downlink HARQ process is disabled or enabled.

Aspect 43: A method of wireless communication performed by a network node, comprising: transmitting a first downlink communication that includes a respective semi-static uplink hybrid automatic repeat request (HARQ) configuration for each of a plurality of uplink HARQ processes associated with a user equipment (UE), wherein the respective semi-static uplink HARQ configurations indicate whether an uplink HARQ mode is enabled or disabled for each of the plurality of uplink HARQ processes; and transmitting a second downlink communication that includes a dynamic uplink HARQ configuration for an uplink HARQ process of the plurality of uplink HARQ processes, wherein the dynamic uplink HARQ configuration at least partially overrides a semi-static uplink HARQ configuration, indicated in the first downlink communication, associated with the uplink HARQ process.

Aspect 44: The method of Aspect 43, wherein the first downlink communication comprises a radio resource control (RRC) communication; and wherein the second downlink communication comprises a downlink control information (DCI) communication.

Aspect 45: The method of any of Aspects 43-44, wherein the dynamic uplink HARQ configuration includes a dynamic HARQ round-trip time (RTT) timer configuration that overrides a semi-static HARQ RTT timer configuration included in the semi-static uplink HARQ configuration for the uplink HARQ process.

Aspect 46: The method of any of Aspects 43-45, wherein the dynamic uplink HARQ configuration is indicated by one or more bits included in a field in the second downlink communication; and wherein the field is dedicated for indicating the dynamic uplink HARQ configuration.

Aspect 47: The method of any of Aspects 43-46, wherein a logical channel priority (LCP) prioritization is based at least in part on a semi-static uplink HARQ configuration, in the first downlink communication, for the uplink HARQ process regardless of the dynamic uplink HARQ configuration for the uplink HARQ process.

Aspect 48: The method of any of Aspects 43-47, wherein the dynamic uplink HARQ configuration includes a dynamic physical downlink control channel (PDCCH) monitoring timer configuration that overrides a semi-static PDCCH monitoring timer configuration included in the semi-static uplink HARQ configuration for the uplink HARQ process.

Aspect 49: The method of any of Aspects 1-24, wherein selectively initiating PDCCH monitoring comprises: selectively initiating PDCCH monitoring based at least in part on the RRC configuration and the DCI communication.

Aspect 50: An apparatus for wireless communication at a device, comprising a processor; memory coupled with the processor; and instructions stored in the memory and executable by the processor to cause the apparatus to perform the method of one or more of Aspects 1-49.

Aspect 51: A device for wireless communication, comprising memory, and one or more processors coupled to the memory, the memory comprising instructions executable by the one or more processors to cause the device to perform the method of one or more of Aspects 1-49.

Aspect 52: A device for wireless communication, comprising a memory and one or more processors coupled to the memory, the one or more processors configured to perform the method of one or more of Aspects 1-49.

Aspect 53: An apparatus for wireless communication, comprising at least one means for performing the method of one or more of Aspects 1-49.

Aspect 54: A non-transitory computer-readable medium storing code for wireless communication, the code comprising instructions executable by a processor to perform the method of one or more of Aspects 1-49.

Aspect 55: A non-transitory computer-readable medium storing a set of instructions for wireless communication, the set of instructions comprising one or more instructions that, when executed by one or more processors of a device, cause the device to perform the method of one or more of Aspects 1-49.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a radio resource control (RRC) configuration that indicates that hybrid automatic repeat request (HARQ) feedback associated with a downlink HARQ process is disabled or enabled;
receiving a downlink control information (DCI) communication that overrides the RRC configuration;
selectively transmitting HARQ feedback, associated with the downlink HARQ process, for a downlink transmission based at least in part on the DCI communication; and
selectively initiating, based at least in part on selectively transmitting the HARQ feedback, physical downlink control channel (PDCCH) monitoring associated with the downlink HARQ process based at least in part on at least one of the RRC configuration or the DCI communication.

2. The method of claim 1, wherein selectively initiating PDCCH monitoring comprises:
selectively initiating PDCCH monitoring based at least in part on the RRC configuration and the DCI communication.

3. The method of claim 1, wherein the RRC configuration indicates that HARQ feedback associated with the downlink HARQ process is enabled; and
wherein the DCI communication overrides the RRC configuration and indicates, in a HARQ resource offset field in the DCI communication, that HARQ feedback associated with the downlink HARQ process is disabled.

4. The method of claim 1, wherein the RRC configuration indicates that HARQ feedback associated with the downlink HARQ process is disabled;
wherein the DCI communication overrides the RRC configuration and indicates that HARQ feedback associated with the downlink HARQ process is enabled; and
wherein selectively transmitting the HARQ feedback, associated with the downlink HARQ process, for the downlink transmission comprises:
transmitting the HARQ feedback, associated with the downlink HARQ process, for the downlink transmission based at least in part on the DCI communication indicating that HARQ feedback associated with the downlink HARQ process is enabled.

5. The method of claim 1, wherein the RRC configuration indicates, in a HARQ resource field in the DCI communication, that HARQ feedback associated with the downlink HARQ process is disabled.

6. The method of claim 1, wherein the RRC configuration indicates, in a HARQ resource offset field in the DCI communication, that HARQ feedback associated with the downlink HARQ process is disabled.

7. The method of claim 1, wherein the RRC configuration indicates that a PDCCH monitoring timer associated with the downlink HARQ process is disabled; and
wherein selectively initiating PDCCH monitoring associated with the downlink HARQ process comprises:
refraining from initiating the PDCCH monitoring timer based at least in part on the RRC configuration indicating that the PDCCH monitoring timer associated with the downlink HARQ process is disabled.

8. The method of claim 1, wherein the RRC configuration indicates that a PDCCH monitoring timer associated with the downlink HARQ process is enabled; and
wherein selectively initiating PDCCH monitoring associated with the downlink HARQ process comprises:
initiating the PDCCH monitoring timer based at least in part on the RRC configuration indicating that the PDCCH monitoring timer associated with the downlink HARQ process is enabled.

9. The method of claim 1, wherein the RRC configuration comprises:
a first field indicating that HARQ feedback associated with the downlink HARQ process is disabled or enabled; and
a second field indicating whether a PDCCH monitoring timer associated with the downlink HARQ process is disabled or enabled.

10. The method of claim 1, wherein the DCI communication comprises:
a first field indicating that HARQ feedback associated with the downlink HARQ process is disabled or enabled; and
a second field indicating whether a PDCCH monitoring timer associated with the downlink HARQ process is disabled or enabled.

11. The method of claim 1, wherein selectively initiating PDCCH monitoring comprises:
selectively initiating, based at least in part on selectively transmitting the HARQ feedback, a PDCCH monitoring timer based at least in part on whether a HARQ process identifier bitmap is included in the RRC configuration.

12. The method of claim 1, wherein selectively initiating PDCCH monitoring comprises:
selectively initiating, based at least in part on selectively transmitting the HARQ feedback, a PDCCH monitoring timer based at least in part on whether at least one of one or more downlink HARQ processes, including the downlink HARQ process, is enabled for the UE.

13. The method of claim 1, wherein selectively initiating PDCCH monitoring comprises:
selectively initiating, based at least in part on selectively transmitting the HARQ feedback, a PDCCH monitoring timer based at least in part on whether at least one of one or more downlink HARQ processes, including the downlink HARQ process, is enabled in the RRC configuration.

14. The method of claim 1, wherein selectively initiating PDCCH monitoring comprises:
selectively initiating, based at least in part on selectively transmitting the HARQ feedback, a PDCCH monitoring timer based at least in part on a quantity of downlink HARQ processes, including the downlink HARQ process, that is enabled for the UE.

15. A user equipment (UE) for wireless communication, comprising:
memory; and
one or more processors coupled to the memory, the memory comprising instructions executable by the one or more processors to cause the UE to:
receive a radio resource control (RRC) configuration that indicates that hybrid automatic repeat request (HARQ) feedback associated with a downlink HARQ process is disabled or enabled;
receive a downlink control information (DCI) communication that overrides the RRC configuration;
selectively transmit HARQ feedback, associated with the downlink HARQ process, for a downlink transmission based at least in part on the DCI communication; and
selectively initiate, based at least in part on selectively transmitting the HARQ feedback, physical downlink control channel (PDCCH) monitoring associated with the downlink HARQ process based at least in part on at least one of the RRC configuration or the DCI communication.

16. The UE of claim 15, wherein the RRC configuration indicates that a PDCCH monitoring timer associated with the downlink HARQ process is disabled; and
wherein the instructions, executable to cause the UE to selectively initiate PDCCH monitoring associated with the downlink HARQ process, are executable to cause the UE to:
refrain from initiating the PDCCH monitoring timer based at least in part on the RRC configuration indicating that the PDCCH monitoring timer associated with the downlink HARQ process is disabled.

17. The UE of claim 15, wherein the RRC configuration indicates that a PDCCH monitoring timer associated with the downlink HARQ process is enabled; and
wherein the instructions, executable to cause the UE to selectively initiate PDCCH monitoring associated with the downlink HARQ process, are executable to cause the UE to:
initiate the PDCCH monitoring timer based at least in part on the RRC configuration indicating that the PDCCH monitoring timer associated with the downlink HARQ process is enabled.

18. The UE of claim 15, wherein the RRC configuration comprises:
a first field indicating that HARQ feedback associated with the downlink HARQ process is disabled or enabled; and
a second field indicating whether a PDCCH monitoring timer associated with the downlink HARQ process is disabled or enabled.

19. A network node for wireless communication, comprising:
memory; and
one or more processors coupled to the memory, the memory comprising instructions executable by the one or more processors to cause the network node to:
transmit a radio resource control (RRC) configuration that indicates that hybrid automatic repeat request (HARQ) feedback associated with a downlink HARQ process is disabled or enabled;
transmit a downlink control information (DCI) communication that overrides the RRC configuration; and
selectively receive HARQ feedback, associated with the downlink HARQ process, for a downlink transmission based at least in part on the DCI communication.

20. The network node of claim 19, wherein the RRC configuration indicates that HARQ feedback associated with the downlink HARQ process is enabled; and
wherein the DCI communication overrides the RRC configuration and indicates, in a HARQ resource field in the DCI communication, that HARQ feedback associated with the downlink HARQ process is disabled.

21. The network node of claim 19, wherein the RRC configuration indicates that a physical downlink control channel (PDCCH) monitoring timer associated with the downlink HARQ process is disabled or enabled.

22. The network node of claim 19, wherein the RRC configuration comprises:
a first field indicating that HARQ feedback associated with the downlink HARQ process is disabled or enabled; and
a second field indicating whether a physical downlink control channel (PDCCH) monitoring timer associated with the downlink HARQ process is disabled or enabled.

23. The network node of claim 19, wherein the DCI communication comprises:
a first field indicating that HARQ feedback associated with the downlink HARQ process is disabled or enabled; and
a second field indicating whether a physical downlink control channel (PDCCH) monitoring timer associated with the downlink HARQ process is disabled or enabled.

24. A method of wireless communication performed by a network node, comprising:
transmitting a radio resource control (RRC) configuration that indicates that hybrid automatic repeat request (HARQ) feedback associated with a downlink HARQ process is disabled or enabled;
transmitting a downlink control information (DCI) communication that overrides the RRC configuration; and
selectively receiving HARQ feedback, associated with the downlink HARQ process, for a downlink transmission based at least in part on the DCI communication.

25. The method of claim 24, wherein the RRC configuration indicates that HARQ feedback associated with the downlink HARQ process is disabled;
wherein the DCI communication overrides the RRC configuration and indicates that HARQ feedback associated with the downlink HARQ process is enabled; and
wherein selectively receiving the HARQ feedback, associated with the downlink HARQ process, for the downlink transmission comprises:
receiving the HARQ feedback, associated with the downlink HARQ process, for the downlink transmission based at least in part on the DCI communication indicating that HARQ feedback associated with the downlink HARQ process is enabled.

26. The method of claim 24, wherein the RRC configuration indicates, in a HARQ resource field in the DCI communication, that HARQ feedback associated with the downlink HARQ process is disabled.

27. The method of claim 24, wherein the RRC configuration indicates, in a HARQ resource offset field in the DCI communication, that HARQ feedback associated with the downlink HARQ process is disabled.

28. The method of claim 24, wherein the RRC configuration indicates that a physical downlink control channel (PDCCH) monitoring timer associated with the downlink HARQ process is disabled or enabled.

29. The method of claim 24, wherein the RRC configuration comprises:
a first field indicating that HARQ feedback associated with the downlink HARQ process is disabled or enabled; and
a second field indicating whether a physical downlink control channel (PDCCH) monitoring timer associated with the downlink HARQ process is disabled or enabled.

30. The method of claim 24, wherein the DCI communication comprises:
a first field indicating that HARQ feedback associated with the downlink HARQ process is disabled or enabled; and
a second field indicating whether a physical downlink control channel (PDCCH) monitoring timer associated with the downlink HARQ process is disabled or enabled.
